(19) United States
(12) Patent Application Publication
(10) Pub. No.: US 2016/0098405 A1
(43) Pub. Date: Apr. 7, 2016

(54) Document Curation System

(71) Applicant: Docurated, Inc., New York, NY (US)

(72) Inventors: Alex Gorbansky, New York, NY (US); Ryan Cooke, New York, NY (US); Irene Tserkovny, New York, NY (US); Adam Duston, Hoboken, NJ (US); Robert Patterson, New York, NY (US); James Federbush, New York, NY (US); Robert Kanarek, New York, NY (US)

(21) Appl. No.: 14/871,015

(22) Filed: Sep. 30, 2015

Related U.S. Application Data
(60) Provisional application No. 62/058,375, filed on Oct. 1, 2014.

(51) Int. Cl. G06F 17/30

(52) U.S. Cl. CPC G06F 17/3053; G06F 17/30312; G06F 17/30011

(57) ABSTRACT

A document curation system facilitates finding previously-created objects, such as text and charts, in electronic business documents, such as word processing documents and slide presentations files stored in documents of a separate document storage system. The document curation system enables a user to search for objects, without a priori knowledge of which documents might contain the objects. The system presents found objects, as well as objects that are similar to the found objects, and allows the user to select one or more of the presented objects. The system harmonizes display aspects of the user-selected objects and generates a new document from them. A user can query the document curation system, and the system accesses an index, which stores normalized versions of objects from the document storage systems to fulfill the query.

### CROSS REFERENCE TO RELATED APPLICATIONS

This application claims the benefit of U.S. Provisional Patent Application No. 62/058,375, filed Oct. 1, 2014, titled “Document Curation System,” the entire contents of which are hereby incorporated by reference herein, for all purposes.

### TECHNICAL FIELD

The present invention relates to electronic document systems and, more particularly, to such systems that facilitate finding previously used document objects and creating new documents from found objects.

### BACKGROUND ART

Computer systems facilitate generating and storing a wide range of business electronic documents, such as word processing documents, slide presentations, portable document formatted documents, spreadsheets, computer-aided design (CAD) documents and the like. Unfortunately, computers make it so easy to generate these documents that many users generate so many documents, the users later have difficulty finding a particular document or a particular graph, slide or paragraph of interest. This often leads to the users recreating documents from scratch, which leads to multiple similar or identical documents being stored on the computers.

This situation is exasperated in organizations, such as sales or marketing organizations, in which many people generate and use such documents. Often, when a member of such an organization wishes to create a new document, portions of previously created documents would be useful to include, possibly with minor edits. However, as noted, finding just the right slide, paragraph or spreadsheet is difficult.

Many document management systems, such as Autonomy WorkSite, Lotus Domino Document Manager and Microsoft Outlook, store documents and make them available to members of organizations. However, finding a particular paragraph, chart or slide, in such a document management system is difficult or impossible, without a priori knowledge of which document contains the desired element.

Furthermore, creating a new document from portions of existing documents is difficult, because the existing documents may have been created using a variety of display aspects, such as fonts, colors, type sizes, styles and the like. Simply cutting and pasting together portions of existing documents often leads to a “Frankenstein's monster” of a document, with a variety of inconsistent and disharmonious display aspects.

### SUMMARY OF EMBODIMENTS

A document curation system, according to embodiments of the present invention, facilitates finding previously-created objects, such as text and charts, in electronic business documents, such as word processing documents and slide presentations files stored in documents of a separate document storage system. The document curation system acts as an intermediary between users and document storage systems and/or document management systems, such as Microsoft Exchange Server, Autonomy WorkSite, Salesforce.com Inc. file sharing system and Google Drive file storage and synchronization service. Documents stored on local drives, network attached storage (NAS) drives and file servers may also be treated as document storage systems.

The document curation system maintains an index that stores, among other things, normalized versions of objects from the document storage systems. The normalized objects are content-wise identical to corresponding objects in the document storage systems, however the normalized objects are free of formatting, such as color, size and font. A user can query the document curation system, and the system accesses the index to fulfill the query.

The document curation system enables a user to search for objects, without a priori knowledge of which documents might contain the objects. The system presents found objects, as well as objects that are similar to the found objects, and allows the user to select one or more of the presented objects. The system harmonizes display aspects of the user-selected objects and generates a new document from them.

An embodiment of the present invention provides a document curation system. The system curates objects from documents stored in a document storage system. Each document contains at least one object. Each document is organized according to one of a plurality of predefined object models. The document storage system includes an application programming interface (API). The document storage system stores information about each document. The document curation system includes a computer programming interface. The computer programming interface fetches documents, as well as information about the documents, from the document storage system via the document storage system's API.

The document curation system also includes a document analyzer. The document analyzer automatically identifies the object model of each fetched document. The document analyzer also automatically identifies objects in the fetched document, according to the object model of the fetched document.

The document curation system also includes an object normalizer. The object normalizer automatically creates a normalized version of each identified object. The normalized version of the identified object is independent of the object model of the fetched document. The normalized version of the identified object excludes characteristics from the identified object that are irrelevant to contents of the identified object.

The document curation system also includes a hash calculator. The hash calculator automatically calculates a hash value based on each identified object.

The document curation system also includes an object score calculator. The object score calculator calculates a relevance score for each identified object, independent of any user-initiated search.

The document curation system also includes a metadata generator. The metadata generator automatically generates metadata about each identified object. The metadata includes information sufficient to fetch the object from the document storage system.

The document curation system also includes an index database. The index database is distinct from the document storage system. The index database is configured to store information about individual objects.

The document curation system also includes an indexer. The indexer stores the normalized version of the identified object, the hash value, the relevance score and the metadata in the index database for each of a plurality of objects identified by the document analyzer.

The object score calculator may calculate the relevance score based at least in part on identity of an author of the object. The object score calculator may calculate the relevance score based at least in part on frequency with which identical objects exist in other documents in the document storage system. The object score calculator may calculate the relevance score based at least in part on frequency with which similar, but not identical, objects exist in other documents in the document storage system. The object score calculator may calculate the relevance score based at least in part on frequency with which the object has been included in at least one newly created document.

The metadata may further include information identifying an author of the object. The metadata may further include information identifying each user who has used the object in a newly created document.

The document curation system may also include a first user interface. The first user interface may receive a query from a human user. The document curation system may also include a search engine. The search engine may search the index database. The search engine may also identify objects that meet criteria established by the query. The document curation system may also a de-duplicator. The de-duplicator may use hash values to identify, among the objects identified by the search engine, objects that are at least similar, within a predetermined similarity range, to other objects identified by the search engine.

The document curation system may also include a second user interface. The second user interface may display objects identified by the search engine, other than the at least similar objects identified by the de-duplicator.

The document curation system may also include a third user interface. The third user interface may receive indications from the human user. The indications may identify ones of the objects displayed by the second user interface. The third user interface may receive indications identifying an order of the objects.

The document curation system may also include a document generator. The document generator may generate a document containing copies of the objects identified by the human user via the third user interface. The generated document contain the copies of the objects in the order identified by the human user.

The document generator may format a presentation aspect of at least one of the objects identified by the human user, so as to make the presentation aspect consistent with other of the objects identified by the human user.

The document curation system may also include a first user interface that receives a query from a human user. The document curation system may also include a search engine that searches the index database. The search engine identifies objects that meet criteria established by the query.

The document curation system may also include a duplicate identifier. The duplicate identifier uses hash values to identify, among the objects identified by the search engine, objects that are at least similar, within a predetermined similarity range, to other objects identified by the search engine.

The document curation system may also include a second user interface. The second user interface may displays objects identified by the search engine and indicate whether at least similar objects were identified by the duplicate identifier.

The document curation system may also include a first user interface that receives a query from a human user. The document curation system may also include a search engine that searches the index database and identifies objects that meet criteria established by the query. The document curation system may also include a de-duplicator. The de-duplicator uses hash values to identify, among the objects identified by the search engine, objects that are at least similar, within a predetermined similarity range, to other objects identified by the search engine. The de-duplicator thereby identifies a de-duplicated set of objects that does not include the at least similar objects.

The document curation system may also include an object analyzer. The object analyzer parses the de-duplicated set of objects to automatically identify references to additional objects that are not in the objects identified by the search engine. The document curation system may also include a document organizer that automatically determines an order for the de-duplicated set of objects and the additional objects, according to an order of the references identified by the object analyzer. The document curation system may also include a document generator. The document generator automatically generates a document containing copies of the de-duplicated set of objects and the additional objects, according to the order determined by the document organizer.

The document curation system may also include a second user interface. The second user interface may receive indications from the human user identifying ones of the de-duplicated set of objects and the additional objects. The document generator may generate the document, according to the objects identified by the human user in the second user interface.

The document curation system may also include a natural language processor. The natural language processor automatically processes the query from the human user to automatically identify at least one keyword, according to a meaning of the query from the human user. The natural language processor automatically establishes the criteria for the search engine from the at least one keyword.

The document curation system may also include a text adjuster. The text adjuster changes text in at least one object of the de-duplicated set of objects and the additional objects, so as to make wording of the text correct, based on the order determined by the document organizer.

The document generator may format a presentation aspect of at least one of the objects identified by the human user, so as to make the presentation aspect consistent with other of the objects identified by the human user.

### BRIEF DESCRIPTION OF THE DRAWINGS

The invention will be more fully understood by referring to the following Detailed Description of Specific Embodiments in conjunction with the Drawings, of which:

FIG. 1 is a schematic block diagram of an indexing portion of a document curation system, according to an embodiment of the present invention.

FIG. 2 is a schematic diagram of the index database, according to an embodiment of the present invention.

FIG. 3 is a schematic diagram of a document description block of the index database of FIG. 2, according to an embodiment of the present invention.

FIG. 4 is a schematic diagram of an object description block of the index database of FIG. 2, according to an embodiment of the present invention.

FIG. 5 is a schematic block diagram of a user search portion of the document curation system, according to an embodiment of the present invention.

FIG. 6 is a hypothetical screen display generated by a search results user interface of the user search portion of FIG. 5, according to an embodiment of the present invention.

FIGS. 7a and 7b collectively are another hypothetical screen display generated by a search results user interface of the user search portion of FIG. 5, according to an embodiment of the present invention.

FIG. 8 is yet another hypothetical screen display generated by a search results user interface of the user search portion of FIG. 5, according to an embodiment of the present invention.

FIG. 9 is a schematic block diagram of a new document generation portion of the document curation system, according to an embodiment of the present invention.

FIG. 10 FIG. 10 is a flowchart that illustrates operations performed by the indexing portion of FIG. 1, according to an embodiment of the present invention.

FIG. 11 is a flowchart illustrating operations performed by a document analyzer of FIG. 1, according to an embodiment of the present invention.

FIG. 12 is a flowchart of further operations performed by the document analyzer of FIG. 1, according to an embodiment of the present invention.

FIG. 13 is a flowchart that illustrates operations of a hash calculator of FIG. 1, according to an embodiment of the present invention.

FIG. 14 is a flowchart that illustrates operations performed by an object relevance score calculator of FIG. 1, according to an embodiment of the present invention.

FIG. 15 is a flowchart illustrating operations performed by a metadata generator of FIG. 1, according to an embodiment of the present invention.

FIG. 16 is a flowchart illustrating operations performed by an indexer of FIG. 1, according to an embodiment of the present invention.

FIG. 17 is a flowchart illustrating operations performed by a de-duplicator of FIG. 5, according to an embodiment of the present invention.

FIGS. 18 and 19 are schematic block diagrams illustrating operations of an object analyzer of FIG. 9, according to an embodiment of the present invention.

FIG. 20 is a flowchart illustrating some operations of a text adjuster of FIG. 9, according to an embodiment of the present invention.

### DETAILED DESCRIPTION OF SPECIFIC EMBODIMENTS

A document curation system, in accordance with embodiments of the present invention, facilitates finding previously-created elements, such as text, paragraphs, charts, graphs, slides, spreadsheets, images, audio files, video files and the like, in electronic business documents, such as word processing documents, slide presentations, portable document formatted documents, spreadsheet documents, web pages, media files and computer-aided design (CAD) files. We refer to such elements as “objects.” The document curation system enables a user to search for objects, without a priori knowledge of which documents might contain the objects. The system presents found objects, as well as objects that are similar to the found objects, and allows the user to select one or more of the presented objects. The system harmonizes display aspects of the user-selected objects and generates a new document from them.

The document curation system acts as an intermediary between users and document storage systems and/or document management systems (collectively “document storage systems”). A user can query the document curation system, and the system accesses an index, which stores normalized versions of objects from the document storage systems to fulfill the query. The document curation system typically returns objects in response to the user's query although, upon a user's request, collections of objects may be returned or entire documents from which the objects were extracted can also be returned. Some objects are hierarchically organized, such as paragraphs, outlines and/or graphics within pages. The document curation system may automatically assemble several related objects and return the assembly as a query result. Once query results are displayed by the document curation system, a user may request an object or document that contains a found object. In addition, upon a user request, the document curation system may invoke an application program, such as a word processing program, to open a document that contains a found object.

### Index

The document curation system indexes objects that are parts of documents stored by the document storage systems. This index facilitates subsequent searching for objects. The index contains a normalized copy of each object. The normalized copy is generic, in that it includes the semantic contents of the object, such as text of a paragraph, but the normalized copy does not include display aspects, such as font, color or type size. The index also contains a hash value for each generic object, thereby enabling the document curation system to easily identify content-wise identical objects, even if the objects would be displayed differently. The index also contains low-resolution images of objects. These low-resolution images may be used as hash values when searching for identical or similar objects.

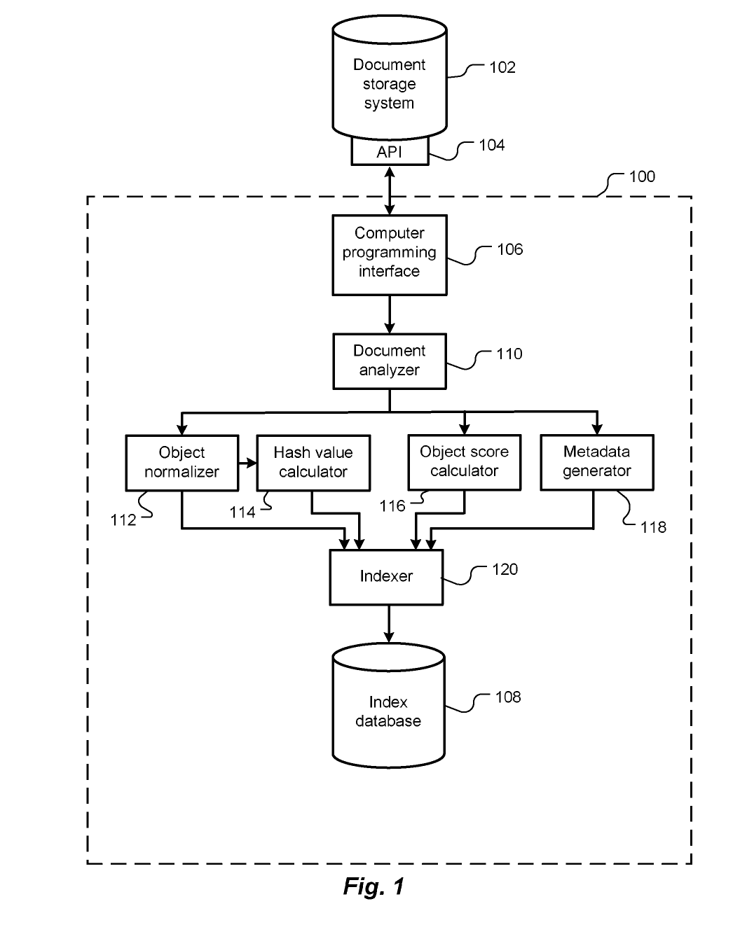

FIG. 1 is a schematic block diagram of an indexing portion 100 of the document curation system, according to an embodiment of the present invention. The indexing portion 100 of the document curation system is coupled to one or more document storage systems, exemplified by document storage system 102. The document storage system 102 in FIG. 1 represents one or more document storage systems. The document storage systems may be interconnected, or each document storage system may be separately connected to the indexing portion 100. The document storage system may be all of the same type or a mixture of types of system may be used. Exemplary document storage systems include Microsoft SharePoint, Box Inc. online file sharing system, Salesforce.com Inc. file sharing system, Jive Software social networking database, Google Drive file storage and synchronization service, Dropbox file hosting service, Microsoft Exchange Server, Autonomy WorkSite, Lotus Domino Document Manager and Microsoft Outlook. Documents stored on local drives or network attached storage (NAS) drives made accessible by an operating system may also be treated as document storage systems. In some embodiments, the document storage system 102 may include a web server, file server, file transfer protocol (FTP) server or other document server. The document storage system 102 stores documents, such as word processing documents, slide presentations, spreadsheet documents, plain (unformatted) text documents and the like, as well as information about each document. The information (also referred to as “attributes”) about each document may include size, creation date, last modification date, owner, protection, etc.

Each such document contains at least one object, such as a paragraph, slide, chart, graph, image, etc. Each document is organized according to a predefined object model. For example, word processing documents may be organized according to Microsoft's Word Object Model, which is publicly available at msdn.microsoft.com/en-us/library/kw65a0we.aspx. Spreadsheet documents may be organized according to Microsoft's Excel Object Model, and slide presentation documents may be organized according to Microsoft's PowerPoint Object Model, both of which are publicly available. Similarly, portable documents may be organized according to the Portable Document Format (PDF), developed by Adobe System and now an open standard. Other types of documents may be organized according to other object models, some of which are publicly available. For documents that do not have publicly available object models, conventional techniques may be used to inspect exemplary documents and reverse-engineer the object models. Plain (unformatted) text documents are organized as a series of lines of text, typically with the end of each line denoted by a special character, such as CR (Carriage Return). The end of the text file's contents is typically denoted by a special character, such as EOF (End of File).

Object models specify how documents are organized, including how objects within the documents may be found, such as displacement from the beginning of the file or some other reference point, descriptions of the objects, such as their sizes, display aspects and the like.

The document storage system 102 includes an application programming interface (API) 104, by which the document storage system 102 may be accessed programmatically, such as to create a document, open an existing document, delete an existing document or obtain an existing document's attributes, although for purposes of the document curation system, the API 104 need only support opening an existing document.

The indexing portion 100 of the document curation system includes a computer programming interface 106 configured to fetch documents, as well as information about the documents, from the document storage system 102 via the document storage system's API 104. The computer programming interface 106 interacts with the document storage system's API 104, according to a published or reverse-engineered protocol. APIs for document storage systems are either publicly documented or can be reverse engineered using conventional techniques.

The indexing portion 100 of the document curation system automatically analyzes documents in the document storage system 102, including automatically identifying objects within the documents, according to the documents' native object models. In some embodiments, the indexing portion 100 parses the document to identify objects in the document. For each object, the indexing portion 100 of the document curation system automatically identifies metadata, assigns the object a relevance score and indexes the objects to support future searches. The relevance score is independent of a given search. Instead, the relevance score is based on information such as who generated the document or object, how many times the object (or a similar object) appears in other documents, and how often or how many times the object has been referenced (found in a search or included in a new composite document). The document curation system stores a normalized version of each found object in an index database 108, as well as a pointer to the source document in the document storage system 102 where the object was found, so the source document can later be fetched.

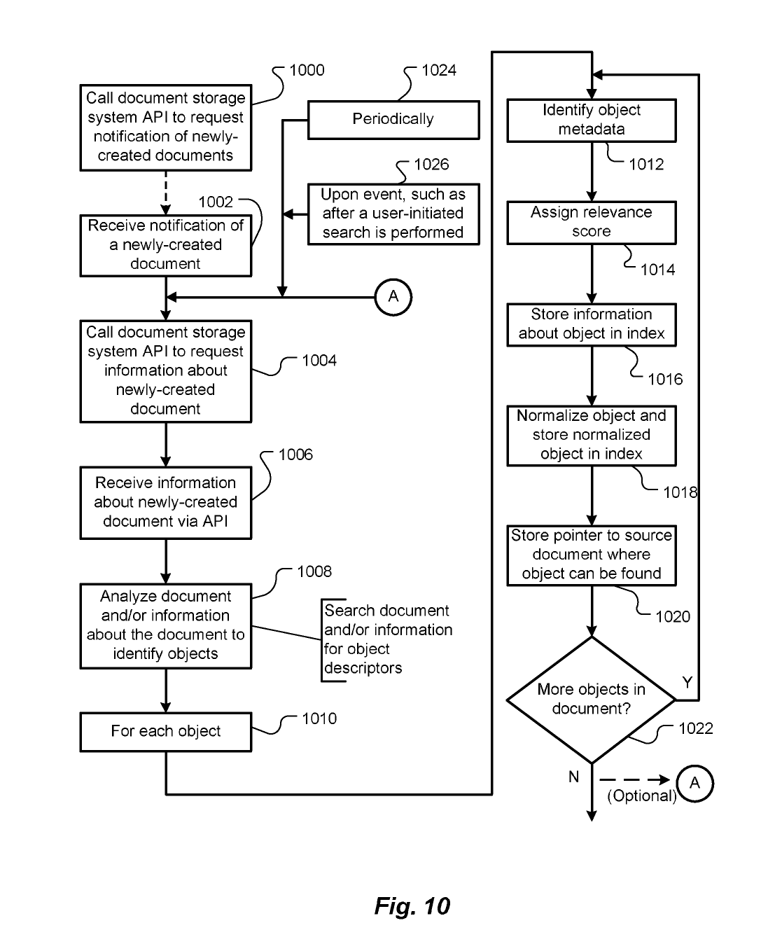

FIG. 10 is a flowchart that illustrates operations performed by the indexing portion 100. At 1000, the indexing portion 100 calls the API 104 (FIG. 1) of the document storage system 102 to request notification of newly-created documents. Some document storage systems 102 accept such requests and respond by calling call-back routines, software interrupts, asynchronous system traps or other entry points whenever new documents are created in the document storage systems 102. When such an event occurs, the document storage system 102 invokes, or causes to be invoked, the call-back routine, etc. Thus, at 1002, the indexing portion 100 receives notification of a newly-created document.

Control passes to 1004, where the indexing portion 1004 calls the document storage system API 104 to request information about the newly-created document. This information may include such items as document name, document type, author, protection code, creation date and time, creation program, keywords, path to the document and the like. At 1006, the indexing portion 100 receives the information.

At 1008, the indexing portion 100 analyzes the document and/or the received information about the document to automatically identify objects within the document. For some document types, the indexing portion 1006 searches for object descriptors that are stored in the document. For some document types, objects that are stored in the document are represented by object descriptors stored in a well-known location within the document. For such document types, the indexing portion 100 reads the object descriptions. At 1010, the indexing portion 100 begins a loop. The loop is executed at least once for each object in the document.

At 1012 the indexing portion 100 identifies object metadata related to the object and stored in the document or elsewhere in the document storage system 102. The metadata may include such items as a project with which a document is related and usage data, i.e., identities and/or numbers of users who opened, viewed, edited, printed, etc., the document via the document storage system 102, times and dates on which the document was accessed and the type of access. For document storage systems 102, such as Google Drive, Microsoft Active Directory and Salesforce.com, that store information about users, such as roles, membership within organizational structures (such as “X is on a team with Y, reports to Z, works on project A, trying to sell product B to person C at company D”), relationships to other users, relationships to clients, etc., the metadata may include such information.

The indexing portion 100 may explicitly request the metadata from the document storage system 100 via the API 104. Optionally or alternatively, as with the request to receive notifications of newly-created documents 1000, the indexing portion 100 may request the document storage system 102 to be notified whenever the document is used or periodically or occasionally to receive updated usage metadata. Optionally or alternatively, the indexing portion 100 may periodically or occasionally query the document storage system 100 for updated metadata.

For document storage systems 100 that are implemented as file servers or personal computers, a client application program may be installed on the file server or personal computer, and the client application program may automatically access activity logs on the file server or personal computer to ascertain when a document is newly created, opened, viewed, printed, edited, etc. The client application program may probe the file server or personal computer to collect the metadata. The client application program may enable file and/or directory “watch points,” so it is notified by a local operating system, file system or other document manager whenever a file is changed. The client application program sends information it collects to the indexing portion 100, such as via an inter-process communication channel, e-mail, network packets, shared memory, etc.

At 1014, the indexing portion 100 calculates and assigns a relevance score to the object. Relevance scores may also be calculated and assigned to documents and pages. As noted, the relevance score is calculated independently of any user query. The relevance score may be calculated according to a formula (mathematical function) that takes as parameters any information the indexing portion 100 has about the object, its containing page or its containing document. One parameter may be the object's previous relevance score. Thus, some information about an object may boost (increase) the object's relevance score, whereas other information may decrease the object's relevance score. For example, a new object's relevance score may be increased, due to the newness of the object, whereas an old object's relevance score may be decreased, due to the age of the object.

In another example, a document or object's relevance score may be increased, such as by one point, for each time the document or object is viewed, either within the document's document storage system 102 or within the document curation system. The increase or decrease in the relevance score may be calculated according to a more complex formula, such as a weight (such as 10) multiplied by a ratio of a number of views by one group of users, such as people in an executive staff, to a number of views by another group of users, such as people in a marketing department, weighted by a value that decreases with time into the past at which time the view occurred.

The identity, title, role, etc. of the person accessing the document may influence an amount by which the relevance is increased or decreased. For example, if a document is associated with a particular project and the document is accessed by a person working on the same project, the relevance may be adjusted to a greater extent than if the document is accessed by a person not working on the project.

The relevance score may be calculated, at least in part, based on whether the document is a version of another document. As noted, the index contains a hash value for each generic object, thereby enabling the document curation system to easily identify content-wise identical objects, and therefore content-wise identical documents, even if the objects would be displayed differently. The indexing portion 100 compares the hash for the document to hash values of other objects and documents to identify identical or similar other documents. Optionally or alternatively, a new version of a file may be identified by the fact that it was given the same file name and path as an older file. This filename and path information is available via the API 104 to the document storage system 102.

New versions of existing documents may have relevance scores calculated based at least in part on relevance scores of the existing documents. For example, if an existing document has a relevance score with positive contributions as a result of having been accessed many times or recently, the relevance score of the content-wise identical new version of the document may be given a positive relevance score, or its relevance score may be increased, by a value calculated from the relevance score of the existing document. Giving a new version of a document such a positive relevance score may be based on an assumption that, because the existing document was deemed to be relevant, a content-wise new version should be equally, or nearly equally, relevant to users, despite the fact that the new version may not have yet been accessed by any, or many, users.

Alternatively, all new versions of documents may be given a positive relevance score, relative to new documents that are not new versions of existing documents, at least for an initial time period, such as three days, after the new versions are created. Optionally, after the time period, any “boost” given to the new version document's relevance scores may be taken away, i.e., the relevance score may be reduced, either gradually over several days or all at once.

At 1016, the indexing portion 100 stores information about the object in the index database 108 (FIG. 1). At 1018, the object is normalized, as described herein, and the normalized version of the object is stored in the index database 108. At 1020, information about how the document or object can be retrieved from the document storage system 10 is stored in the index database 108. The retrieval information may include the document's file name, path, server name, etc. If more than one separate document storage system 102 is available, information identifying the document storage system 102 that stores the document is also stored in the index database 108. Each document storage system 102 may have its own API 104, or one API 104 may provide access to multiple document storage systems 102. The index database 108 is described in more detail herein. If more objects remain to be processed in the document, at 1022 control returns to 1012.

As noted, the indexing portion 100 may operate periodically, occasionally, such as in response to an event, such as after a user-initiated search has been performed, continuously or semi-continuously. Thus, if no more objects remain to be processed in the current document, at 1022 control may pass to 1004 to process any documents that may have been created while operations 1006-1022 were being performed. Optionally, a timer may periodically 1024 invoke 1004. Optionally, event-based triggers may occasionally 1026 invoke 1004.

Thus, returning to FIG. 1, the indexing portion 100 of the document curation system automatically analyzes documents in the document storage system 102, assigns relevance scores to found objects and stores normalized versions of the found objects in the index database 108, before user searches are performed. Similarly, the indexing portion 100 may operate continuously, periodically or occasionally to refresh and augment the index database 108, such as to discover newly created and newly revised documents, thereby keeping the index database 108 current with the document storage system 102. No user action is necessary to keep the index database 108 up-to-date. This is unlike the prior art. User searches are performed against the index database 108, using the previously-assigned relevance scores. This is also unlike the prior art. Of course, after a user-initiated search is performed, the indexing portion 100 can again automatically analyze documents, such as to discover newly created documents, in the document storage system 102 and refresh or replace the index database 108, such as to update object or document relevance scores, but this is not done to satisfy any user-initiated search.

As noted, the computer programming interface 106 is configured to fetch documents, as well as information about the documents, from the document storage system 102 via the document storage system's API 104. That is, the computer programming interface 106 uses protocols associated with the API 104 to fetch the documents and information. A document fetched from the document storage system 102 is referred to as a “source document.” A document analyzer 110 is configured to automatically identify the object model of a fetched document and automatically identify objects in the fetched document, according to the object model of the fetched document. Typically, each document includes an identification of its object model somewhere within the document, such as in a document header. Optionally or alternatively, a document's object model may be identified by the documents file type. For example, file type DOCX typically is associated with Microsoft Word documents. In some cases, the document's object model type is stored in a file system directory or other file system or operating system data structure.

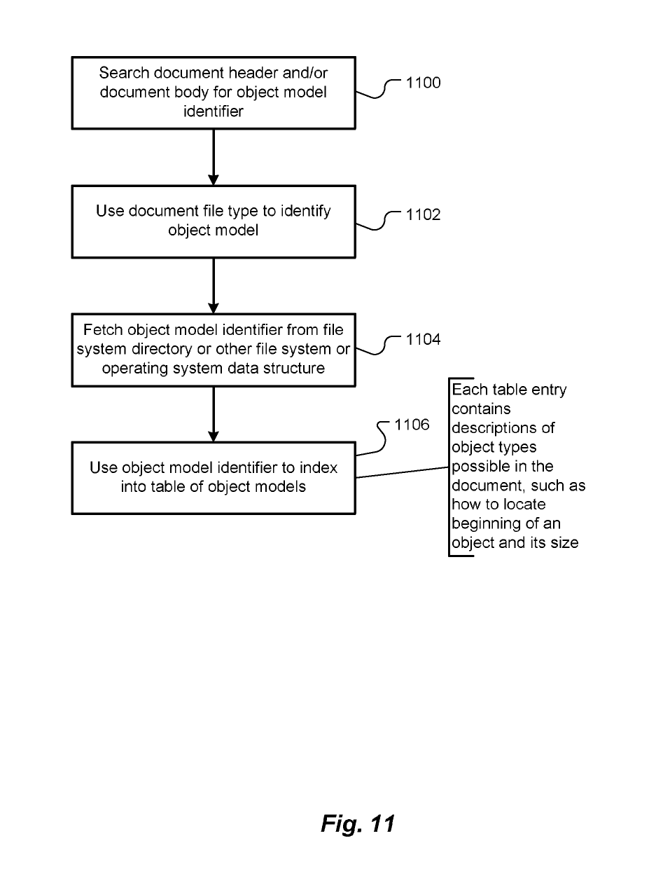

FIG. 11 is a flowchart illustrating operations performed by the document analyzer 110, according to an embodiment of the present invention. The document analyzer 110 analyzes documents about which information is received from the document storage system 102 (operation 1006 in FIG. 10). At 1100, the document analyzer 110 searches the document's header and/or the document's body for an object model type identifier. At 1102, the document's file type may be used to identify the object model type. At 1104, the object model type identifier is fetched from a file system or operating system data structure. In some embodiments, a table lists supported object model types. At 1106, the identified object model type of the document is used to index into the table. Each table entry may contain descriptions of object types supported by the object model, i.e., object types that may be found in the document. Of course, every document may not contain all the object types the object model supports. For each object type, the table entry stores information about how to locate the object in the document. In some cases, this information includes a byte offset from the beginning of the document to the beginning of the object within the document, as well as a size in bytes of the object. Using this information, the document analyzer 110 locates each object in the document.

As noted, the objects in the documents stored by the document storage system 102 are stored according to respective object models. The object model for a document type typically specifies, for example, data fields of the objects, including widths and positions of the data fields. However, conceptually similar data fields, such as text fields, may be stored in different ways in different types of documents, i.e., documents having different object models. For example, a text field may be stored as a null-terminated string in one type of document, whereas a text field may be stored as a counted string in another type of document. For example, PDF is a binary format that uses counted strings, whereas PPTX is a zipped directory of XML files, which are null-terminated. XML can also be terminated by tags.

For each object type, the table entry stores information about how the object is stored, such as null-terminated or counted string, number of bits (for numeric data values), etc.

### Object Normalizer

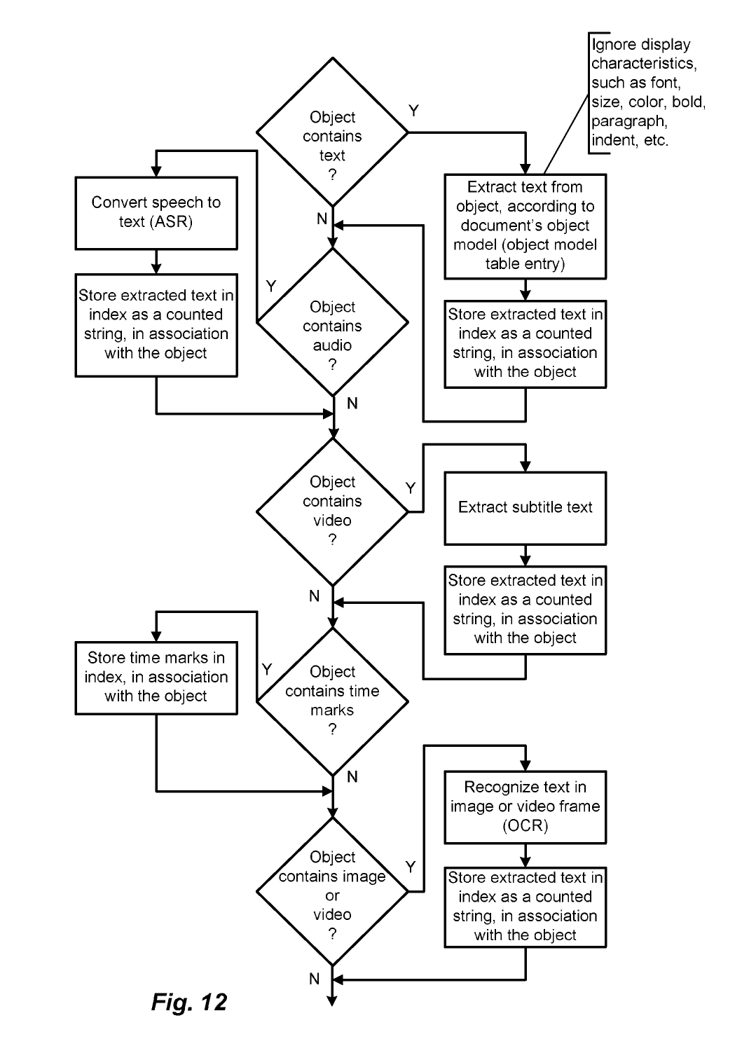

An object normalizer 112 is configured to automatically create a normalized version of each object identified by the document analyzer 110. FIG. 12 is a flowchart of operations performed by the document analyzer 110, according to an embodiment of the present invention. The normalized version of the identified object, which is eventually stored in the index database 108, is independent of the object model of the fetched source document. All objects found by the document analyzer 110 are normalized according to a single, possibly arbitrary, object model. For example, regardless of the way in which a text field is stored in a source document, the normalized version of the text object stores the text as a counted string, or according to any other suitable object model.

Furthermore, the object normalizer 112 removes display characteristics, such as display attributes, that are unnecessary to ascertain semantic meaning of the object. For example, representational, display and/or rendering attributes, such as orientation, font size, text color and type size, are removed. Thus, an output of the object normalizer 112 is a set of normalized objects, all formatted according to a single object model, regardless of the object model of the source document.

For audio files, the normalizer 112 performs automatic speech-to-text conversion to generate a transcript of the audio, and the normalizer 112 stores at least a subset of the transcript as text in the index database 108. For video files, the normalizer 112 performs automatic speech-to-text conversion on the audio track of the video file. If the video file includes subtitles, the normalizer 112 stores the subtitle text in the index database 108. For linear files, such as audio or video files, that contain time marks, such as SMPTE timecodes, the normalizer 112 stores the time marks in association with the objects to facilitate displaying start time and duration when an object is displayed and for searching for a particular start time or length (in time) of object. For image objects, the normalizer 112 performs optical character recognition (OCR) to extract any text in the image, for storage in the index database 108. Similarly, if video frames include text, the normalizer 112 performs OCR on the frames and stores resulting text in the index database 108.

A hash calculator 114 is configured to calculate a hash value for each object identified by the document analyzer 110. The hash value is a numeric value. Hash values may be stored in any suitable format, such as unsigned longwords, hexadecimal or encoded as alphanumeric strings. Any suitable hash value formula may be used for text or other data in the object. For example, bytes used to store a spread sheet or an image may be hashed, as is well known. However, unlike conventional hashing, the hash calculator 114 calculates the hash value based on contents of the object after it has been normalized. Therefore, objects that may be rendered differently according to their native object models, yet contain identical semantic content, have identical hash values. Thus, unlike the prior art, embodiments of the present invention identify semantically identical objects as being identical and can, therefore, de-duplicate a set of objects, even if the objects may be presented differently by their native application programs.

The hash calculator 114 may optionally or additionally be configured to calculate a locality-sensitive hash value. A locality-sensitive hash function maps similar inputs to hash values that differ by at most m, where m is a small integer, as is well known in the art. Some embodiments of the hash calculator 114 enable a user to set m or to select from a set of predetermined values of m, so as to set the level of similarity required for a match, such as “similar,” “very similar” and “nearly identical.” In some embodiments, m may be predetermined or set by a parameter, such as by an environment variable. Thus, similar, but not identical, objects will have similar hash values and can, therefore, be identified, as discussed herein.

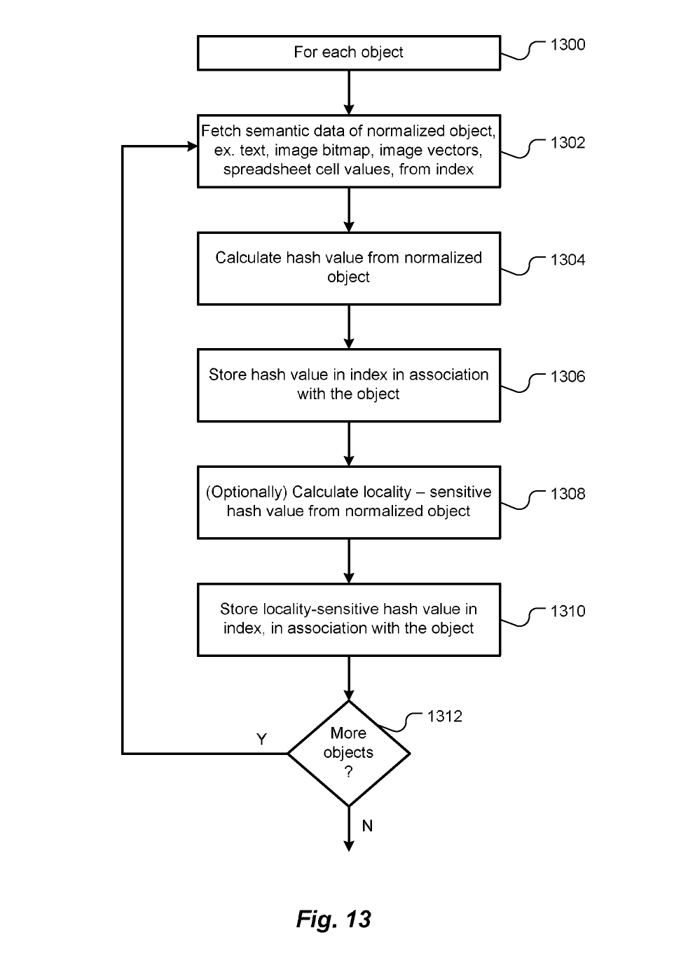

FIG. 13 is a flowchart that illustrates operations of the hash calculator 114, according to an embodiment of the present invention. At 1300, the hash calculator 114 operates on each object of a document, such as the newly-created document, about which information is requested at 1004 (FIG. 10). At 1302, semantic data of a normalized object is fetched, such as from the index database 108 or from the object normalizer 112. The semantic data may include text, image bitmap, image vectors, spreadsheet cell values or the like, depending on the type of the object.

At 1304, a hash value is calculated, according to a suitable hash value function. Many suitable hash value functions are well known in the art. At 1306, the calculated hash value is stored in the index, in association with the object.

Optionally, at 1308, a locality-sensitive hash value is calculated from the normalized object according to a suitable locality-sensitive hash value function. Many suitable locality-sensitive hash value functions are well known in the art. At 1310, the locality-sensitive hash value is stored in the index database 108, in association with the object. At 1312, if more objects are in the document, control returns to 1302.

An object relevance score calculator 116 is configured to calculate a relevance score for each object identified by the document analyzer 110, independent of any user-initiated search. In the prior art, such as Google searches, a relevance score for a file may be calculated for each user-initiated search, for example based on which keyword caused the file to be found and the position of the keyword within a user's search string. In contrast, as noted, according to embodiments of the present invention, the relevance score is calculated before a user-initiated search is entertained. The relevance score for an object is calculated when the object is found by the document analyzer 110, and the calculated relevance score is stored in the index database 108.

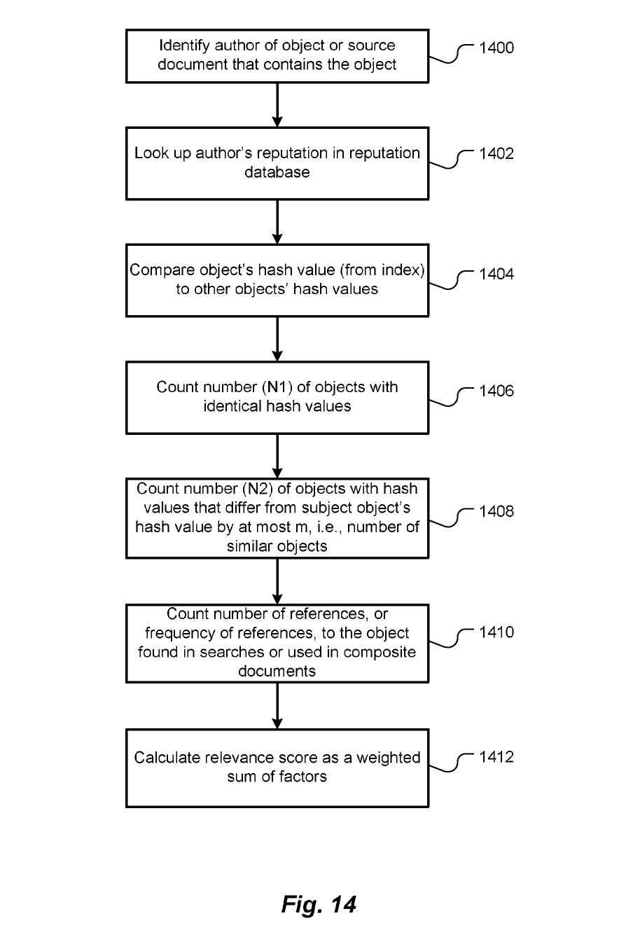

The relevance score may be calculated according to any suitable formula. FIG. 14 is a flowchart that illustrates operations performed by the object relevance score calculator 116, according to an embodiment of the present invention. In some embodiments, the relevance score is calculated based at least in part on identity of an author of the object. The author of a document that contains the object may be deemed to be the author of the object. At 1400, the object relevance score calculator 116 identifies an author of the object or the source document that contains the object. A table or other database stores reputation values for authors. At 1402, the score calculator looks up the author in the table.

Relevance scores for objects represented in the index database 108 may be recalculated from time to time, based on updated statistics collected by the document curation system. For example, as users perform queries searching for objects and select objects for newly created documents, the indexing portion 100 of the document curation system may keep track of authors of documents whose objects are selected. Authors may be assigned scores, based on how frequently their documents or objects are selected, and the relevance scores of objects in the index database 108 may be calculated or revised, based at least in part on the scores of the author of the objects.

In some embodiments, the relevance score is calculated based at least in part on frequency with which identical objects exist in other documents in the document storage system 102. As noted, the indexing portion 100 of the document curation system can identify identical objects, due to their identical hash values. Thus, the number of identical objects in the document storage system 102 may be counted, and the relevance score may be calculated based on the number (absolute number) of identical objects, on a ratio (relative number) of the number of identical objects to the total number of objects in the document storage system 102 or according to some other suitable formula. At 1404, the score calculator 116 compares object hash values of objects in the document to hash values in the index database 108, and at 1406, the number of objects with identical hash values is counted.

In some embodiments, the relevance score is calculated based at least in part on frequency with which similar, but not identical, objects exist in other documents in the document storage system 102. As noted, the index database 108 contains low-resolution images of objects. If two objects have identical low-resolution images, the objects are at least similar, within a range determined by the resolution of the images. Thus, the document curation system may identify objects that are at least similar and calculate the relevance score based on the absolute or relative number of such objects. At 1408, the number of objects with non-identical hash values, but with hash values that differ by at most “m,” are counted.

In some embodiments, the relevance score is calculated based at least in part on frequency with which the object has been included in at least one newly created document. In other words, the score may be positively influenced by the object's having been selected by a human user, after a search presented the object to the user. At 1410, the number of references, or a frequency of references, to the object in searches or used in composite documents is counted. The relevance score may also be calculated, at least in part, based on metadata that describes an object, such as permissions required to access the document that contains the object. For example, objects in documents that are heavily protected against access by users may be given low relevance scores because, as a practical matter, the objects are not available to most users, so there is little point in returning these objects in response to user searches. Low relevance scores lower the probability that these objects are returned in user searches.

Other factors may also, or alternatively, be used to calculate the relevance score. Which factors are used, and their relative weights, may be set by a user or system administrator, via a suitable user interface (not shown), or they may be predetermined or set via parameters, such as environment variables. In some embodiments, the relevance score is based at least in part on “freshness” of an object and/or freshness of the document that contains the object. Freshness means recency of creation. Thus, a recently created document is fresher than an earlier-created document. Similarly, an object recently added to a document is fresher than an earlier-added object. Creation dates of documents can be ascertained from the document management systems. Creation dates of objects are often included in metadata stored in, or in relation to, the containing documents. Version numbers stored by the document storage system 102 may be used instead of, or in addition to, creation date when calculating freshness.

An amount of space occupied by an object, within a page, section or document may be used in calculating the relevance score. Larger objects are typically more important than smaller objects. An object's relevance may, therefore, be proportional to, or at least a function of, the amount of space occupied by the object. Similarly, objects located nearer the beginning of a document are typically more important than objects located further from the beginning Thus, location of an object within a document, such as the object's absolute page number or relative page number, may be used to calculate the relevance score.

The type of the document that contains an object may be used to calculate the relevance score. For example, word processing documents may be deemed more relevant than e-mail messages. The relative relevance of various file types (document types) may set by a user or system administrator, or they may be predetermined according to a desired schedule of values. Similarly, various object types, such as text, graphs, audio, etc., may be given relative levels of relevance, and these levels may be used to calculate the relevance score.

An object document's source, such as its location within a directory hierarchy, may be used to calculate the relevance score. For example, documents stored near the top of the directory hierarchy may be deemed to be more relevant than documents stored further down the hierarchy. Furthermore, keywords in the document's path may be used to increase or decrease the document's relevance. For example, documents whose paths include words such as “draft,” “temp,” “temporary,” “obsolete,” “old” or “junk,” may be deemed to have low relevance, whereas documents whose paths include words such as “final,” “BOD” (board of directors), “published” or “new,” may be deemed to have high relevance.

At 1412, the relevance score is calculated as a weighted sum, or other suitable mathematical combination, of one or more of the factors described herein and optionally or alternatively other factors along the lines described herein.

In addition to calculating a relevance score for each object, as described above, in some embodiments, the document analyzer 110 also calculates a relevance score for each document found in the document storage system 102. The relevance score for a document may be calculated as an aggregation of the relevance scores of objects found within the document. For example, a document relevance score may be an average of the relevance scores of the document's objects. In another example, the average object relevance score is multiplied by a fraction, such as 0.1, times the number of objects found in the document.

Optionally or alternatively, the document relevance score may be calculated based at least in part on identity of an author of the document, frequency with which identical and/or similar documents exist in the document storage system, frequency with which objects from the document have been included in at least one newly created document and the like. For example, an author may develop a good reputation as a result of relatively many of the author's objects or documents having been selected by users from search results. Other factors that may be used in calculating a document relevance score include length of the document, metadata or tags retrieved from other systems. For example, Salesforce.com Inc. file sharing system has “opportunities” associated with documents. The number of these opportunities may be used in calculating a document's relevance score. Search trends, such as from Google or Twitter, may be used in the relevance score calculation. For example, a document's relevance may be increased, if the document's title, subject or keywords match a trend. In addition, the factors discussed above, with respect to relevance of objects, may apply, mutatis mutandis, to documents.

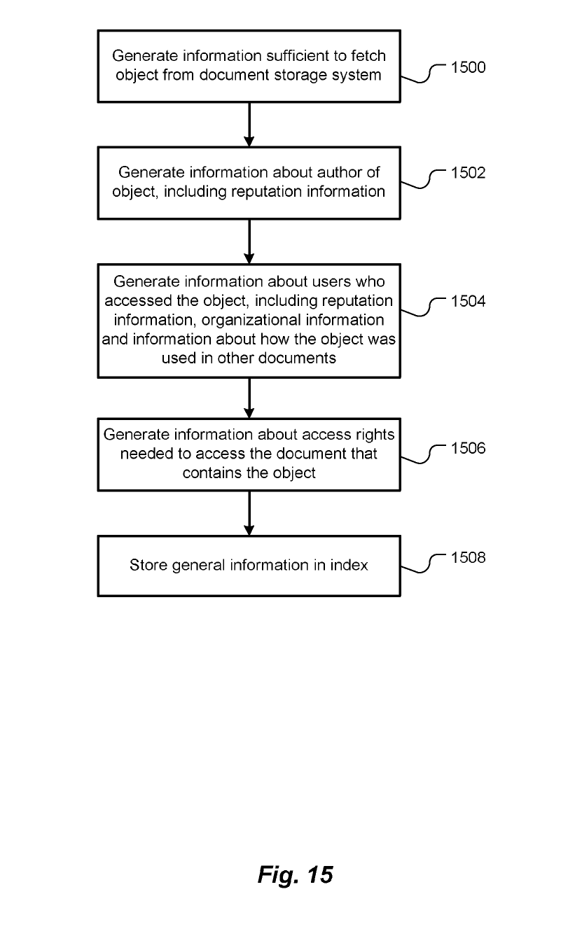

A metadata generator 118 is configured to generate metadata about each object identified by the document analyzer 110. FIG. 15 is a flowchart illustrating operations performed by the metadata generator 118, according to an embodiment of the present invention. The metadata includes information sufficient to fetch the object from the document storage system 102. The information sufficient to fetch the object includes information that the computer programming interface 106 needs to provide to the API 104 of the document storage system 102 to fetch the object or its containing document. This information may include, for example, a path, for example device, directory, file name and file type. At 1500, this information is gathered and/or generated.

The metadata may further include information identifying an author of the object and information identifying each user who has used the object in a newly created document. Such metadata may be used to calculate a relevance score for the object. Gathering and/or generating this information occurs at 1502.

At 1504, information is gathered and/or generated about users who accessed objects, such as reputations of the users, organizations to which the users belong and information about how the objects were used in creating composite documents.

The metadata may further include information about access rights (file permissions) to the document that contains the object. This permission data may be obtained from the document storage system 102 or from an operating system's or file system's file permissions, such as a list of access rights (read, write, execute and/or delete) by user, owner, group and world accounts or an access control list. This permission data may be stored in the document storage system 102 as part of an application program's permission system, such as WorkSite permissions. The permissions stored in the metadata may be used when a user initiates a query to limit objects returned by the query to objects in documents that the user has permission to access (at least read). At 1506, information about access rights, permissions, etc. is gathered and/or generated.

The metadata may also include usage data for objects and documents, such as number of times an object has been returned in response to a query, number of times clicked on by a user to display in more detail, number of times included in a composite document generated by the system, etc., as well as most recent dates of these actions. This kind of information is generated at 1506. At 1508, the gathered and/or generated information is stored by the metadata generator 118 in the index database 108.

Because the document curation system generates and stores hash values for documents, the document curation system can identify documents that are identical or similar, at least within a similarity range governed by the granularity with which dissimilar documents yield identical hash values (“hash collisions”). Documents that are similar to each other may be versions of each other. For example, a document that is largely the same as a document with an earlier creation date or modification date may be a newer version of the earlier document. Similarly, objects may be version of earlier objects. Furthermore, because the document curation system may access more than one document storage system 102, the document curation system can identify identical or similar documents across the document storage systems 102.

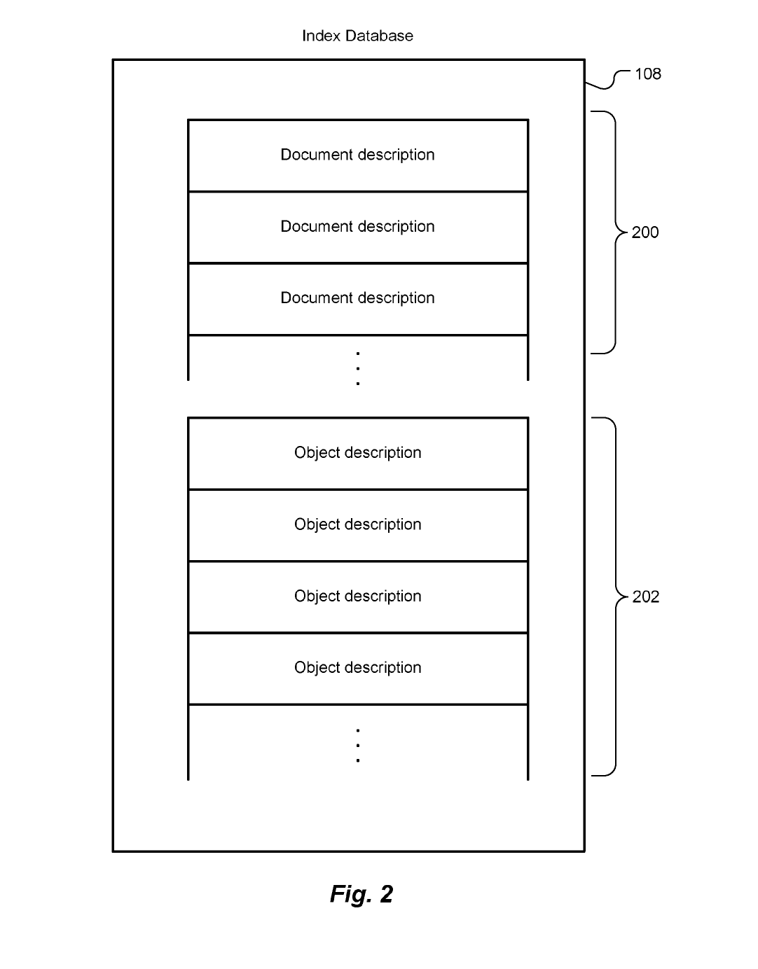

The index database 108 is distinct from the document storage system 102. The index database 108 is configured to store information about individual objects. An indexer 120 is configured to store the normalized version of the identified object, the hash value, the relevance score and the metadata in the index database 108 for each of the objects identified by the document analyzer 110. This data is stored in the index database 108 in association with the object, to facilitate locating and retrieving the data for a given object or object index. FIG. 2 is a schematic diagram of the index database 108, according to an embodiment of the present invention. The index database 108 contains document description blocks 200 and object description blocks 202.

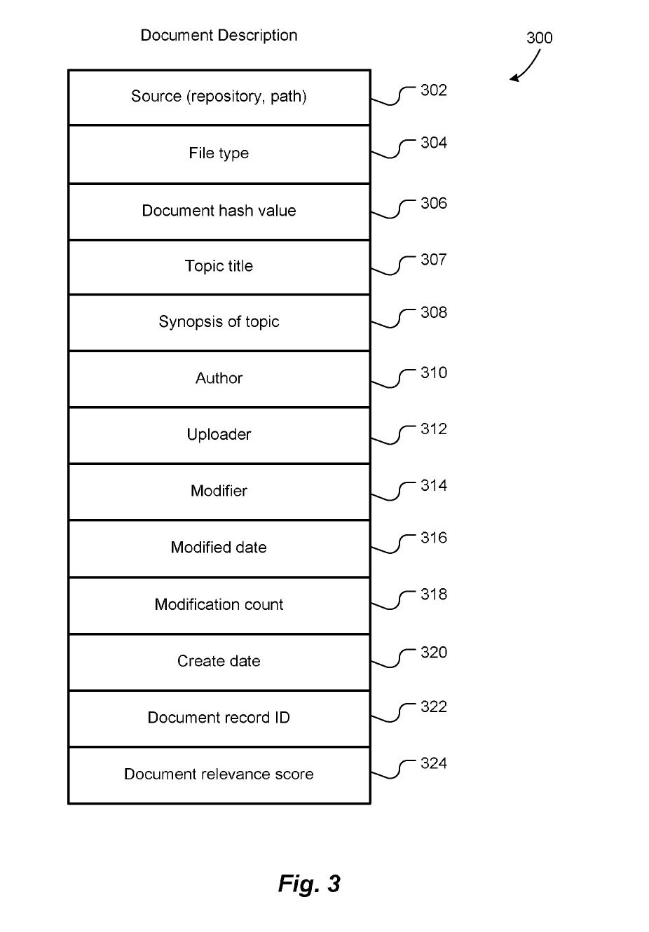

FIG. 3 is a schematic diagram of a document description block 300, according to an embodiment of the present invention. The index database 108 contains a document description block 300 for each document in the document storage system 102 (FIG. 1), of which the document curation system is aware. A source field 302 stores information sufficient for the computer programming interface 106 (FIG. 1) to fetch the document from the document storage system 102. The source field 302 may, for example, contain an identification of the document storage system 102, a device, a directory and a file name. As noted, the index database 108 stores document permissions required to access documents, so as to filter query results and display only objects and documents that a user has permission to access. If a user requests the document curation system to access a document in a document storage system 102, such as by attempting to open a word processing document for editing, the document storage system 102 performs its own access rights procedure, such as by requesting user credentials. A file type of the document may be stored in a file type field 304. As noted, the document analyzer 110 is configured to automatically identify the object model of a fetched document, such as according to the fetched document's object model. The document analyzer 110 stores the file type in the file type field 304.

The document analyzer 110 also calculates a hash value for the entire document and stores the hash value in a hash value field 306. The document hash value 306 may be used to automatically identify other documents in the document storage system 102, or in other document storage systems 102, that are duplicates or versions of the document represented by the document descriptor block 300.

A topic title field 307 contains a title. The title may be provided by a user. Optionally or alternatively, the document curation system may automatically generate the topic title, based on tags, metadata and the like from the document storage system 102. The document curation system may automatically generate the topic title from usage statistics. For example, if several documents are stored in a folder named “Project X” with tags “Reorganization” and “New Business Team,” and users have frequently used the documents while creating new documents, the document curation system may generate a topic tile such as “Popular documents for New Business Team Reorganization—Project X” and apply this topic tile to each document's index database entry.

A synopsis of topic field 308 contains a synopsis of the topic. This field may be filled in a manner similar to that of the topic title field 307. The synopsis topic field may be filled with an extended description of the topic. The synopsis topic field may be filled in by a user or automatically, using known techniques of auto-summarizing documents within a topic.

Several fields store information about people involved in the creation and modification of the document, as well as other historical information about the document. This information may be used to calculate relevance scores for the document or for objects within the document. An author field 310 stores a name of a person who created the document. An uploader field 312 stores a name of a person who uploaded the document to the document storage system 102, which may be different than the name of the author of the document. For example, the document may have been created by an author on some other system and then uploaded by the uploader to the document storage system 102. Similarly, a modifier field 314 stores a name of a person who made the most recent modification to the document. A modification count field 318 stores a number of times the document has been modified, since the document was created. A create date field 320 stores a date on which the document was originally created.

A document record identification (ID) field 322 stores a unique identification of this document description block 300. The document description block 300 can be fetched from the index database 108 using the document record ID. For example, each object description block stored in the index database 108 contains a pointer, implemented as a document record ID, to its containing document's document descriptor block 300. A document relevance score field 324 stores a document relevance score, which is calculated as described above.

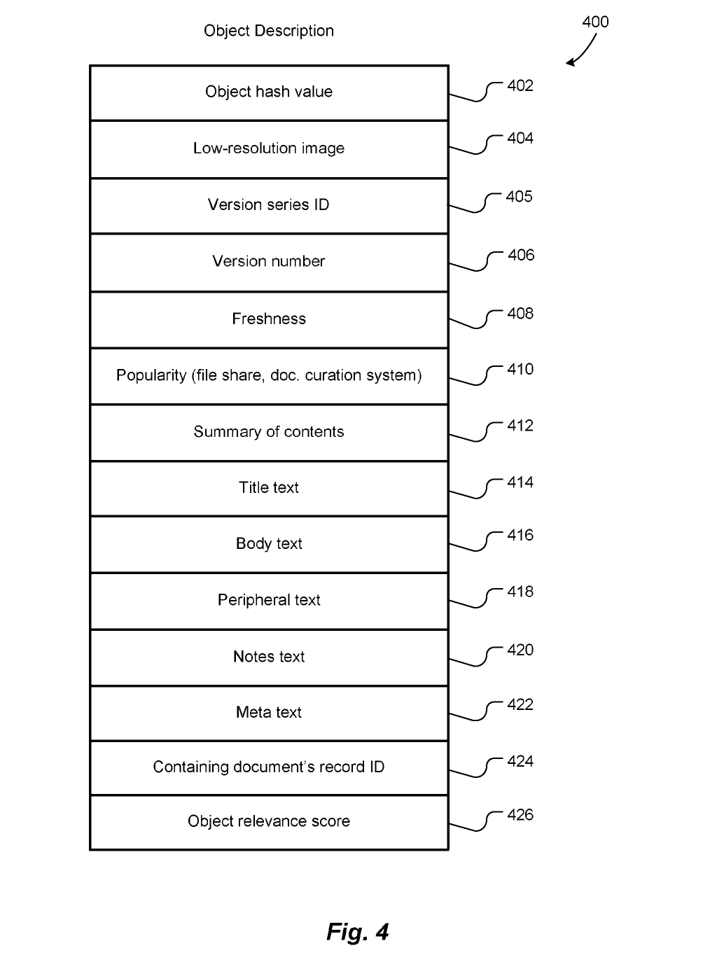

FIG. 4 is a schematic diagram of an object description block 400, according to an embodiment of the present invention. The index database 108 contains an object description block 400 for each object in the document storage system 102, of which the document curation system is aware. A containing document's record ID field 424 contains a document record ID of the document descriptor block 300 (FIG. 3) that contains the object represented by the object description block 400.

As noted, the hash value calculator 114 calculates a hash value for each object. The hash value is stored in an object hash value field 402. The object hash value 306 may be used to automatically identify other objects in the document storage system 102 that are duplicates of the object represented by the object descriptor block 400.

For each object that can be rendered as an image, a low-resolution image of the object is stored in a low-resolution image field 404. The low-resolution image may be used as a thumbnail image icon to represent the object, such as when displaying search results to a user. In addition, similar, although not necessarily identical, objects may be identified as a result of their low-resolution images being identical. To facilitate several levels of similarity, several images may be stored in the low-resolution image field 404, each having been generated according to a different level of resolution.

A version series identifier field 405 contains an identifier, such as a number, wherein objects that have been identified as being similar or identical all have identical version series identifiers. Thus, all similar or identical objects are associated with each other through having a common version series identifier. Among the objects having a single version series identifier field 405 contents, each object is assigned a unique version number 406. Thus, for example, as an object evolves as a result of a series of edits and, therefore, appears in a series of documents, each object is assigned a unique version number within the corresponding version series.

As noted, freshness means recency of creation. A freshness field 408 may be automatically periodically or occasionally updated by the document curation system, such as based on an object's creation date or most recent modification date.

A popularity field 410 may be automatically filled in and periodically or occasionally updated, based on a weighted score calculated from the number of clicks and/or opens of the object, as well as the number of duplicates of the object in other documents.

A summary of contents field 412 may be automatically copied from the containing document, if the document contains an executive summary, abstract or the like. Similarly, a title text field 414 may be automatically copied from the containing document from the first line of the document, a tagged title, the document name or metadata stored by the document storage system 102, in relation to the document. A peripheral text field 418 may be automatically copied from the containing document's headers and/or footers. A notes text field 420 may be automatically copied from a slide presentation document's notes portion, a word processing document's notes, a portable document format documents notes portion or the like.

A metatext field 422 may be used to store other information copied from the document storage system 102, such as tags and other references. The metatext field 422 may include a set of sub-fields based on the object's source. If the document storage system 102 stores text as metadata, tags, identifiers or the like, this text may be copied into the metatext field 422 or into a set of sub-fields of the metatext field 422. For example, Salesforce.com has “opportunity” and “account” metadata, which can be mapped into two different sub-fields. In another example, Box.com may include a “retention_policy” or “contract_details” type, which may be mapped into different sub-fields of the metatext field 422.

Some of the fields, such as summary of contents 412, title text 414, peripheral text 418, notes text 420 and metatext 422, are text fields that generally come from the source document or repository and are used for matching in the index. Other fields, such as freshness 408 and popularity 410, are used by the relevance function to determine where to rank the page/document/object. These fields can be weighted, and adjusted over time, based on a user profile. For example, if a user finds recent information and summary information important, the summary field gets a boosted weight if there is a hit there, and the freshness function will more heavily weigh new information.

For objects that contain text, a body text field 416 stores the text, without formatting (font, size, color, etc.). An object relevance score field 426 stores an object relevance score, which is calculated as described above.

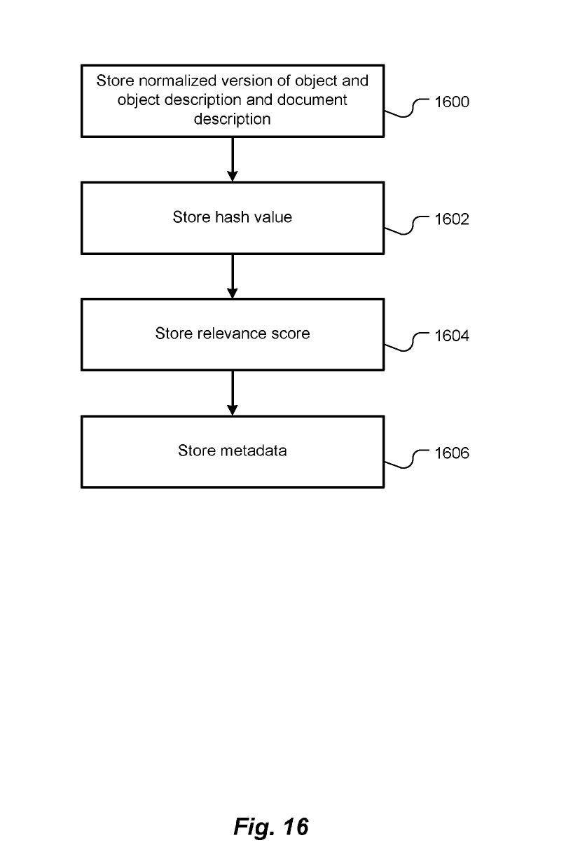

FIG. 16 is a flowchart illustrating operations performed by the indexer 120. At 1600, the indexer 120 stores the normalized version of the identified object in the index database 108 for each of the objects identified by the document analyzer 110. At 1602, the indexer 120 stores the hash value. At 1604, the indexer 120 stores the relevance score. At 1606, the indexer 120 stores the metadata.

Although FIG. 1 shows one index database 108, the index database may be distributed and stored collectively in several locations, such as on several storage servers. In addition, several distinct index databases may be treated as on large collective index database 108. Other components described herein may similarly be divided and/or distributed across several systems and treated as one component.

### User Search Portion of Document Curation System

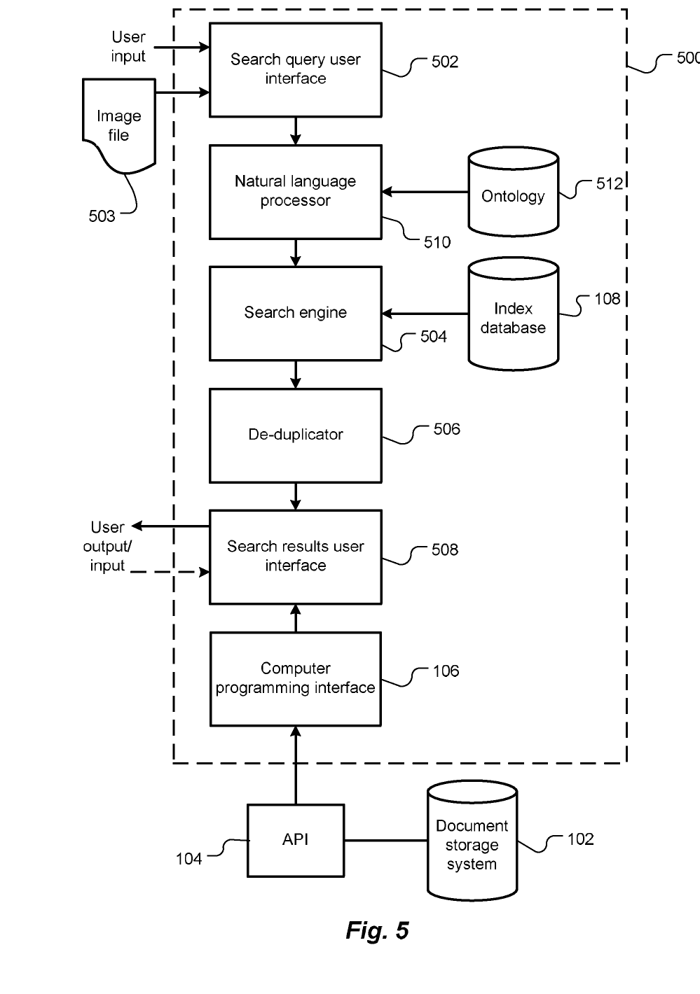

The document curation system enables users to search for objects that may be of interest and select among found objects to assemble a new document. FIG. 5 is a schematic block diagram of a user search portion 500 of the document curation system. A search query user interface 502 accepts user inputs, such as keywords, phrases, authors, create dates, URLs (such as when searching for web clippings) and other selection criteria, which collectively make up a query. Optionally or alternatively, the user may enter a path or URL to an image 503, or select an image from an existing space or search result, and the search portion 500 conducts a search for similar or identical images.

The user search portion 500 of the document curation system may include a natural language processor 510 configured to automatically process the query from the human user to automatically identify at least one keyword, according to a meaning of the query from the human user. The keyword(s) need not necessarily be a word in the human's query. For example, the natural language processor 510 may derive at least some of the keyword(s) from an ontology 512 to expand the user's entry. The natural language processor 510 extracts name-entity recognition and performs language detection and concept expansions. Optionally, the natural language processor 510 matches the keyword(s) with the user's profile, to understand what objects meet the criteria. The user's profile may be used to further assign relevance to objects, such as to select technical documentation, as opposed to sales pitches, depending on the user's interests. The natural language processor 510 may use the keyword(s) to establish the criteria for the search engine. Conventional natural language processor technology may be used, such as Stanford CoreNLP from Stanford University, Natural Language Toolkit from nitk.org and Apache OpenNLP (opennlp.apache.org).

A search engine 504 is configured to search the index database 108 and identify objects that meet criteria established by the query. The search engine 504 takes into consideration the relevance scores of the objects represented in the index database 108 and, optionally, the relevance scores of the source documents for the objects. If the index database 108 contains information about duplicate objects, i.e., identical objects that are stored in different documents, the search engine 504 is likely to return the duplicate objects as part of a search result. If the search criteria include an image 503, the search engine 504 calculates a hash value of the image 503 and uses the hash value as a search criterion. Optionally or alternatively, the search engine 504 may generate a low-resolution version of the image 503 before calculating the hash value, or the search engine 504 may use the low-resolution image as such while searching for a similar or identical image for which the index database 108 contains a low-resolution image (thumbnail).

A de-duplicator 506 is configured to use hash values to identify, among the objects identified by the search engine 504, objects that are identical to other objects identified by the search engine 504, i.e., the duplicate objects. In some cases, it is undesirable to display the duplicate objects to the user, such as to clarify the display of the search results and to simplify the user's analysis of the search results. In such cases, a search results user interface 508 is configured to display objects identified by the search engine, other than the identical objects identified by the de-duplicator.

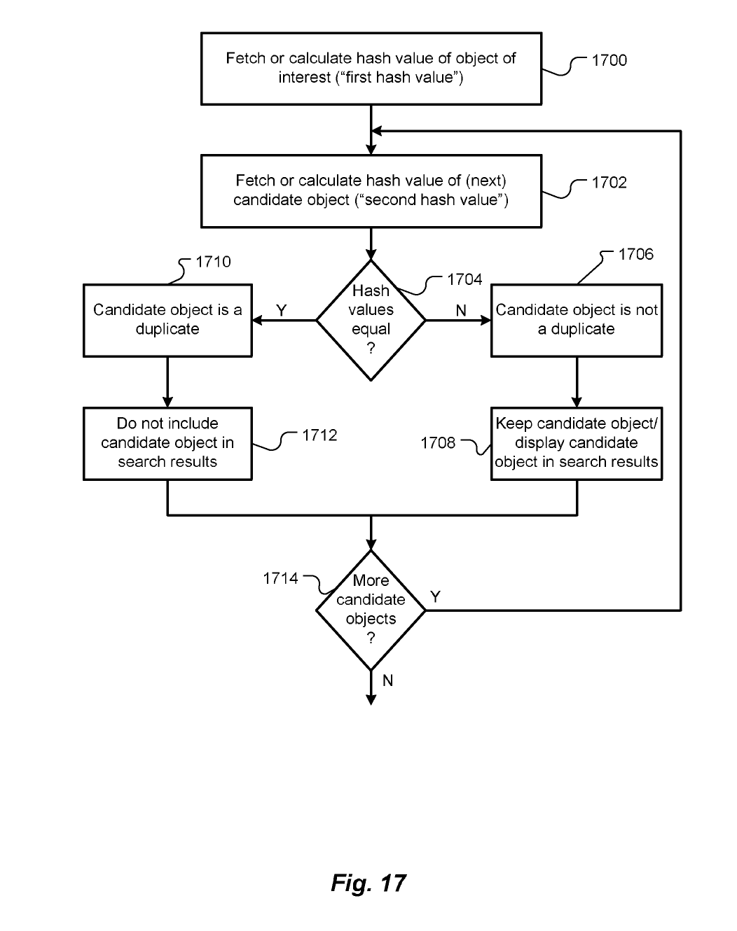

FIG. 17 is a flowchart illustrating operations performed by the de-duplicator 506. At 1700, a hash value is fetched, such as from the index database 108, or calculated for an object of interest, such as an object found as a result of a search. The de-duplicator 506 then checks other objects (“candidate objects”), such as other objects found as a result of the same or a different search, to ascertain whether they are duplicates of the object of interest. At 1702, a hash value is fetched, such as from the index database 108, or calculated for the first candidate object. At 1704, the hash values are compared. If the hash values are not equal, control passes to 1706, in which the candidate object is deemed not to be a duplicate. At 1708, the candidate object is kept and/or displayed as part of a search result.

On the other hand, if at 1704 the hash values are equal, control passes to 1710, where candidate object is deemed to be a duplicate of the object of interest. At 1712, the candidate object is not used, for example the candidate object is not included as part of a search result.

In either case, control passes to 1714. If more candidate objects exist, control returns to 1702, where the next candidate object is considered. The de-duplicator 506 may count the number of objects deemed to be duplicates.

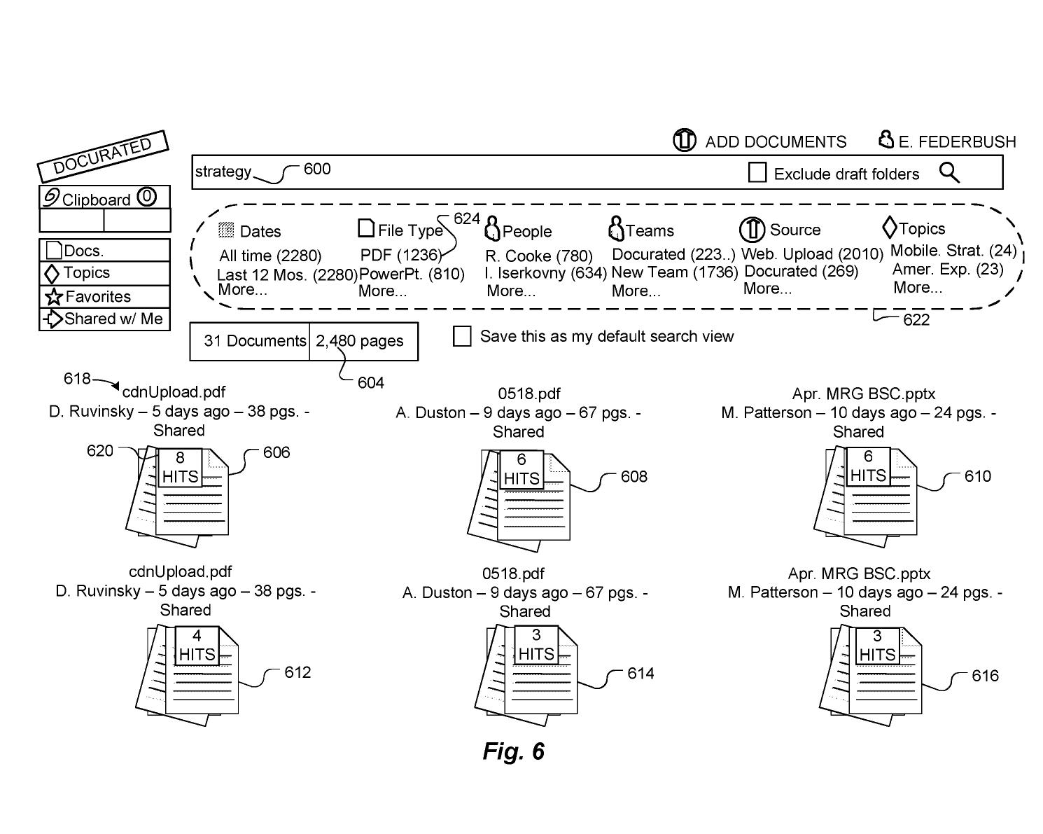

FIG. 6 is a hypothetical exemplary screen display generated by the search results user interface 508 (FIG. 5), showing hypothetical search results of a hypothetical search. In this example, the search query is “strategy” 600, although the search query can be more than one word long. The second user interface 508 (FIG. 5) indicates a number of documents 602 and a number of pages 604 that contain objects that match the search criteria. The found objects are displays, as exemplified at 606, 608, 610, 612, 614 and 616. For each found object 606-616, the search results user interface obtains information about the containing document, such as its file name, author, relative creation date and length, and displays the information, as exemplified at 618. Optionally, the number of duplicates of pages that contain query hits for each object is also indicated, as exemplified at 620. Returning momentarily to FIG. 5, the search results user interface 508 uses the computer programming interface 106 to fetch the source document for each found object from the document storage system 102. For example, if the user chooses to go to a document by invoking an open button, the document curation system opens the document from the document storage system 102 or via the application it was brought in by. For example, a URL to the document on Box.com may be invoked to open the document. Hovering a mouse cursor over a found document or object causes the user interface 508 to display an “open” button, and invoking the open button opens the document. Of course, the document curation system may cache (not shown) some or all of the data from the document storage system 102, to reduce the number of accesses required to the document storage system 102.

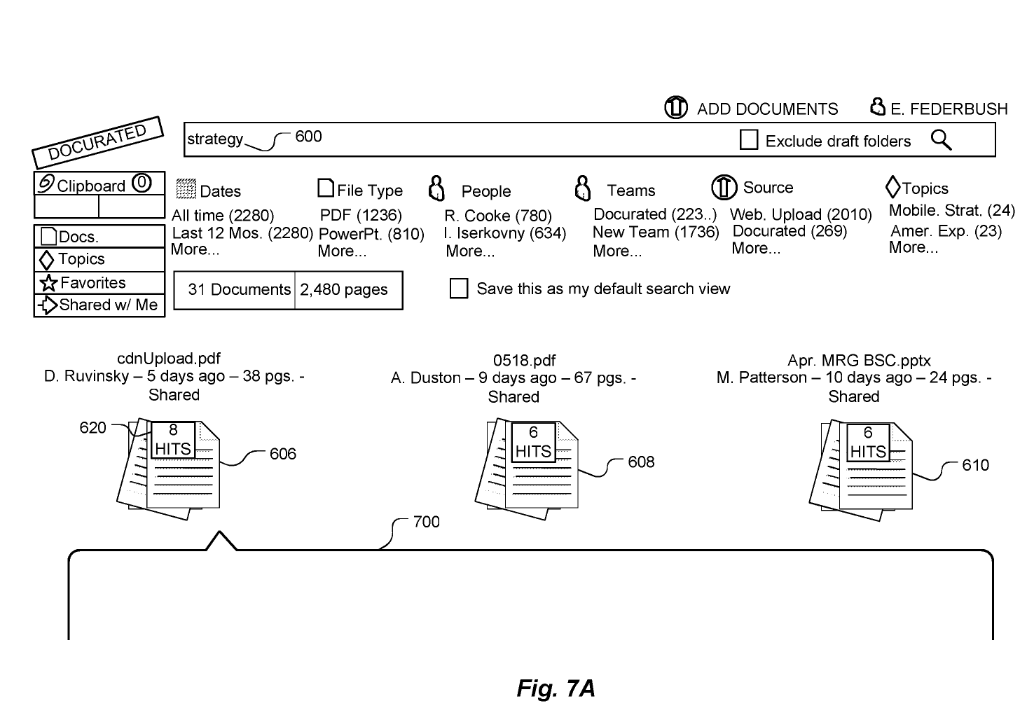

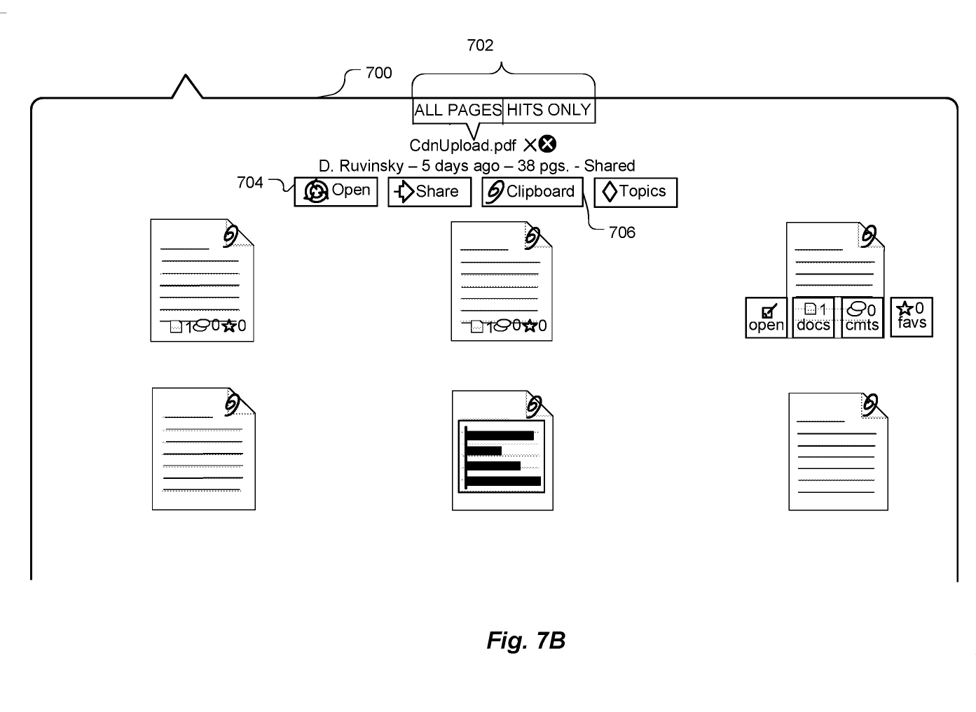

A summary of the documents, in which the searched-for objects were found, is presented across the top of the screen display, as indicated at 622 (FIG. 6). For example, the file types, and numbers of files of each file type, of the containing documents are listed at 624. The search results user interface 508 is configured to accept user inputs. For example, the user can click on any category in the summary 622 to refine the search. For example, the user can click on “File Type” to allow and/or prevent the search results user interface 508 displaying selected file types. In addition, the user can click on a found object, such as object 606, to display the entire contents of the document that contains the object, as shown in a hypothetical exemplary screen display in FIGS. 7a and 7b. Additional pages of the source document are shown at 700. Either all pages of the source document, or only pages containing search hits, may be selected for display with a pair of toggle controls 702.

By clicking on an Open control 704, the user can request the source document be opened. The search results user interface 508 causes the computer programming interface 106 to open the source document with the document's native application program (not shown).

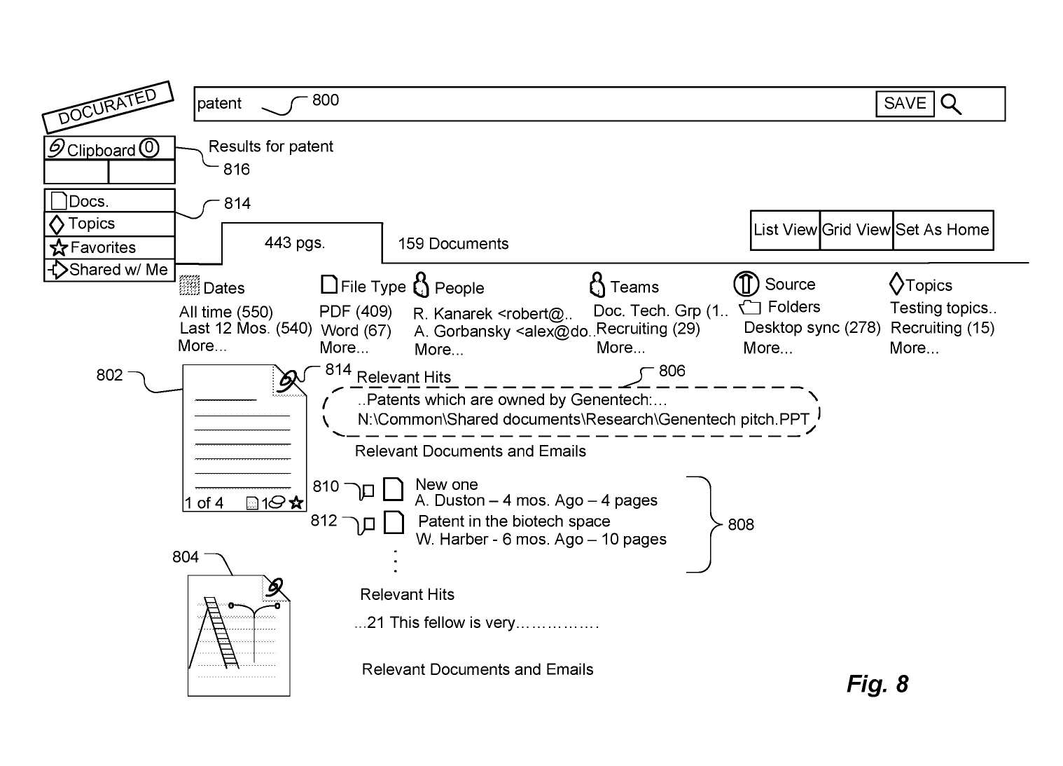

FIG. 8 is a hypothetical exemplary screen display generated by the search results user interface 508, similar to the display shown in FIG. 6, but according to an alternative embodiment. In this example, the search criterion is “patent” 800. In the display shown in FIG. 8, two found objects 802 and 804 are shown. To the right of each found object 802 and 804, the search results user interface 508 displays information 806 about the source document, as well as information 808 about other source documents that contain identical objects. The user can click a check box control, exemplified at 810 and 812, to the left of the document icon to command the search results user interface 508 to select the object for some further operation, such as adding the object to a topic 814 or to a clipboard 816 or viewing version information, display any identical object(s) instead of, or in addition to, the already displayed object 802.

As noted, information in the index database 108 about documents and objects may be used to calculate relevance scores and, therefore, affect whether the documents and objects are returned in response to searches. In addition, this information may be used to provide analytics to users in response to requests for the analytics. For example, the analytics may be presented to the user in the form of a chart of usage of a document in the document curation system, as compared to usage of a document stored in the document storage system 102, a chart of usage of documents by users in the document storage system 102 or comparing usages in multiple document storage systems 102, a chart of usage trends, a chart indicating changes to documents of different file formats (i.e., comparing an amount or rate of changes to documents of one file format to an amount or rate of changes to documents of another file format), a chart of amount or rate of access to documents of various ages, such as to highlight a preference for new or old documents, a chart that cataloging which organizations access or modify documents. These and other analytics may be useful to users or system administrators by illuminating current behavior and allowing the users and administrators to predict future behavior.

### New Document Generation Portion of Document Curation System

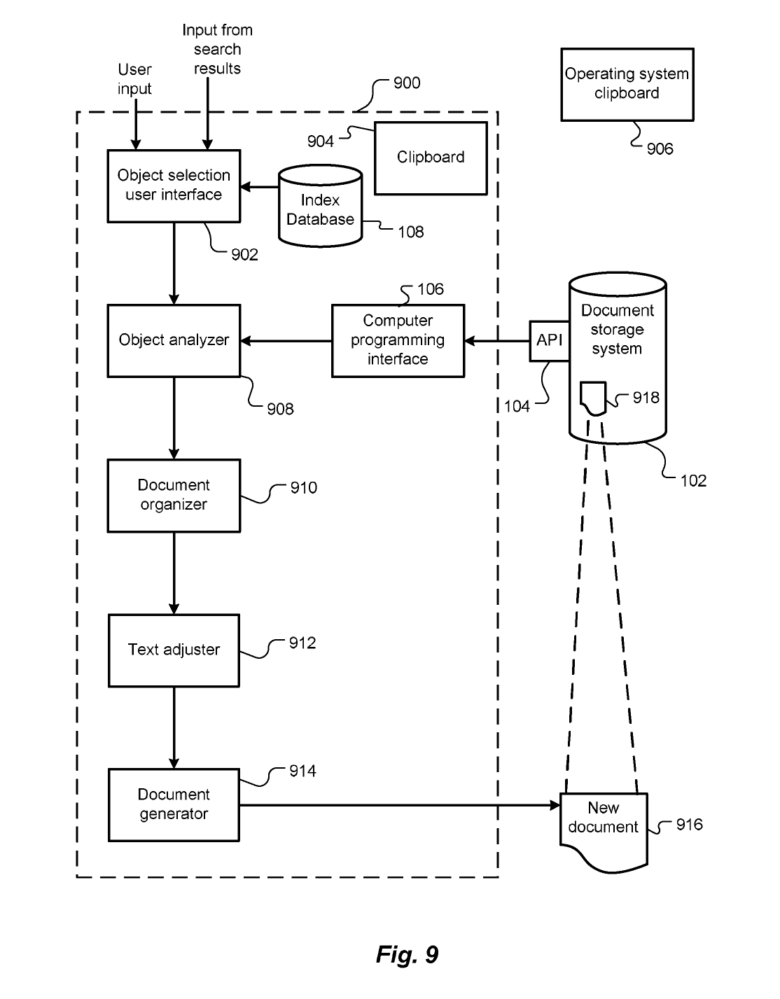

The user may wish to generate a new document from one or more objects returned by the search described with respect to FIGS. 5-8. FIG. 9 is a schematic block diagram of a new document generation portion 900 of the document curation system. An object selection user interface 902 is configured to receive indications from the user identifying objects displayed by the search results user interface 508 and identifying an order of the objects. Using a “Paperclip” icon 816 shown in FIG. 8 (or a similar icon 706 in FIGS. 7a and 7b), the user may command the object selection user interface 902 to save a copy of the object 802 (FIG. 8), or just the hits that are displayed, based on whichever the user is currently viewing, to a temporary storage area 904 maintained by the document curation system. This temporary storage area 904 is referred to as a clipboard. Optionally, the copied object is also stored in the operating system's system-wide clipboard 906.

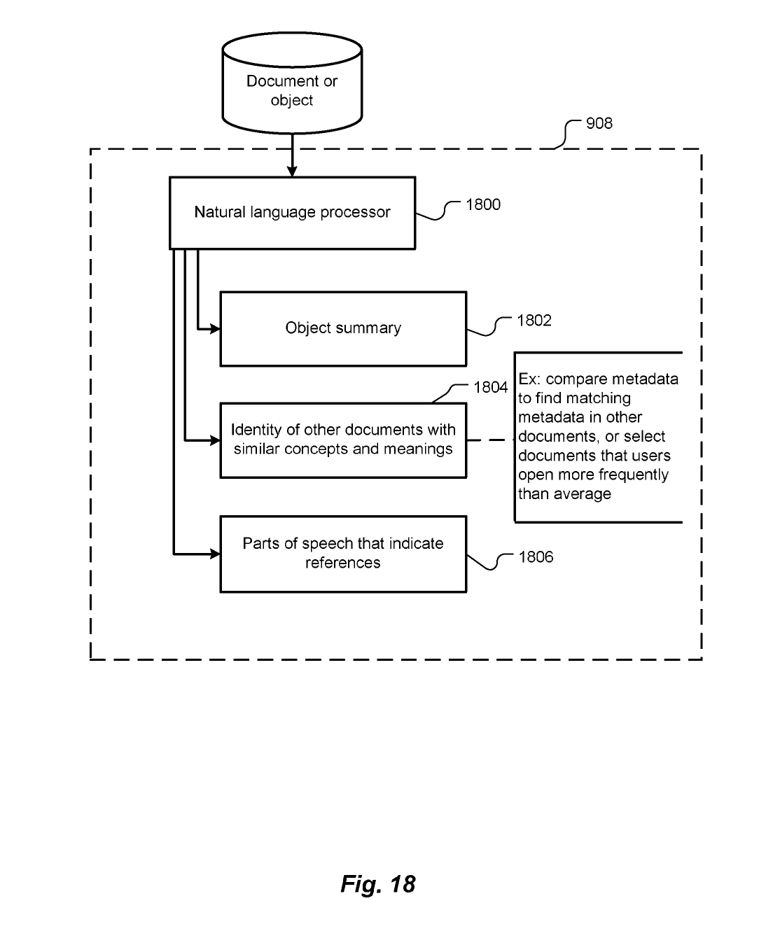

An object analyzer 908 parses the de-duplicated set of objects to automatically identify references to additional objects that are not in the objects identified by the search engine. FIG. 18 is a schematic block diagram illustrating some operations of the object analyzer 908. The object analyzer 908 may automatically identifying additional, likely relevant, documents or objects, based on the user-selected objects. The object analyzer 908 may employ a natural language processor 1800 for several purposes, including summarizing existing objects 1802, identifying other documents and/or objects with similar concepts and meanings 1804 and identifying parts of speech 1806 that indicate references (as discussed herein) to narrow down a whole corpus of text to just those references that indicate, or likely indicate, content existing on another page. The process of summarizing content with natural language processing is different than the natural language processing used for querying concept expansion. The object analyzer 908 identifies additional, relevant documents and/or objects 1804, based on a natural language processing-based understanding, as well as metadata matches or similarities. For example, if an object is part of a document from a sales “opportunity” in Salesforce.com, which may be identified as such based on metadata obtained from Salesforce.com, other documents also associated with that opportunity would be good suspects. Popularity of documents, based on user usage, may also be used to identify additional documents or objects.

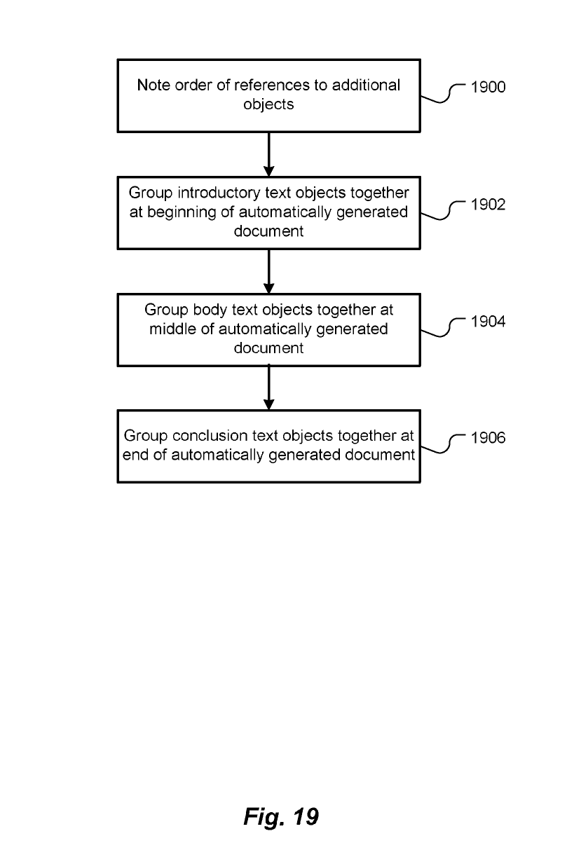

The object analyzer 908 notes an order of the references to the additional objects, based on the order of the concepts and meanings the object analyzer 908 encounters while it processes the de-duplicated set of objects. Returning to FIG. 9, a document organizer 910 automatically determines an order for the de-duplicated set of objects and the additional objects, according to an order of the references identified by the object analyzer 908. FIG. 19 is a flowchart illustrating some operations of the object analyzer 908 and operations of the document organizer 910. At 1900, the object analyzer 908 notes the order of the references to the additional objects. The document organizer 910 may be driven largely by contextual clues, although some natural language processing may be used to automatically determine if, for example, text is introductory in nature, “middle” or conclusion. At 1902, the document organizer 910 automatically moves all introductory text together near the beginning of the automatically generated document 916. At 1904, the document organizer 910 automatically moves all middle text together near the middle of the automatically generated document 916, and at 1906 the document organizer 910 automatically moves all conclusion text together near the end of the automatically generated document 916.

For example, text that includes phrases such as “In conclusion . . . ” may be deemed by the document organizer 910 to be conclusion text, whereas text that includes phrases such as “Section III—Body” may be deemed to be middle text. Objects, such as slides, that appear at or near the beginning or end of a document may be identified as introductory or summary objects, respectively, based on their relative location in the source document or associated number, such as slide number, page number or outline number or level of indentation. Other contextual clues can come from a page level itself, such as the use of titles, large versus small font (where large font size may imply content introductory content), title versus footer, structure of page, location on page, etc. Based on user adjustments and a larger corpus of use, this mechanical understanding may become better over time via machine learning.

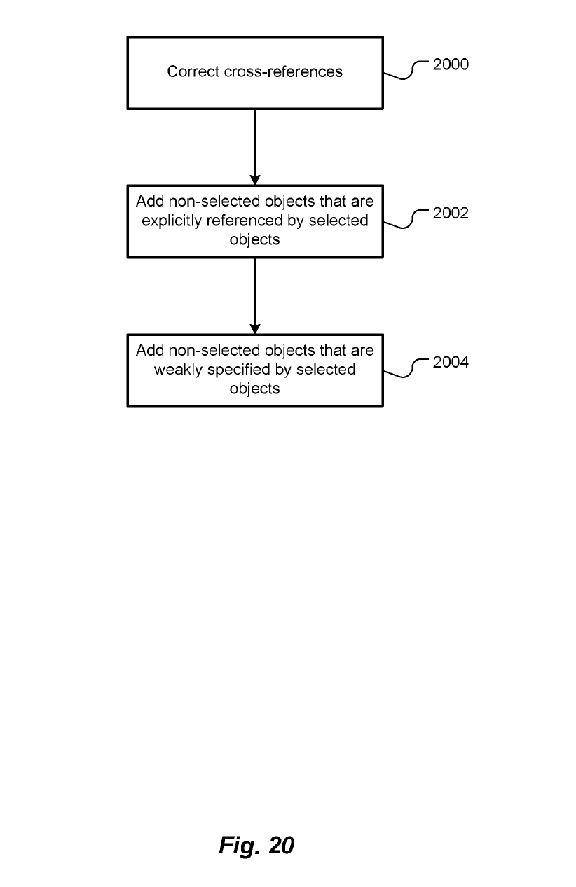

A text adjuster 912 may be used to automatically change text in an object of the de-duplicated set of objects, so as to make wording of the text correct, based on the order determined by a document organizer 910. FIG. 20 is a flowchart illustrating some operations of the text adjuster 912. For example, at 2000, if text objects from pages 3 and 4 of a document are selected, but the objects are reordered so they appear in pages 1 and 7, respectively, in a new document, the text adjuster 912 corrects cross-references, such as “see drawing on page 4,” so the cross-references refer to the correct page numbers. Similarly, if paragraph or sections of the selected text are numbered, the text adjuster 912 renumbers the paragraphs or sections consecutively and consistently, and the text adjuster 912 corrects cross-references, such as “as described in section 4.7.3,” to the paragraphs or sections.

Furthermore, if a selected object refers to an object that the user did not select, the text adjuster 912 automatically adds the non-selected object to the set of objects at 2002. For example, if a selected paragraph refers to “FIG. 7,” but the figure is not in any selected object, the text adjuster 912 automatically obtains the figure from the document storage system 102 and adds it to the set of objects.

The two described operations by the text adjuster 912 may be performed based on “strongly specified” objects, such as explicit references to page numbers, figure numbers, tables, charts and the like. In addition, at 2004, the text adjuster 912 may employ natural language processes to identify “weakly specified” objects, based on a semantic analysis of selected objects. For example, if a selected text object includes “the second sentence of the last paragraph, on the previous page,” the text adjuster 912 may analyze the text and automatically determine which paragraph is being referenced and replace the text with an explicit reference to the referenced paragraph and/or add the referenced paragraph to the set of selected objects.

Weakly specified objects may be referenced in selected text by keywords/phrases, such as “demonstrated in,” “see,” “as discussed in,” “previous paragraph,” “above,” “below” and “herein.” Using these keywords/phrases as hints, the text adjuster 912 may construct a map of referenced objects within a document and references to the objects. Such a map facilitates obtaining referenced portions of the document.

A document generator 914 generates a document 916 containing copies of the objects identified by the user in the object selection user interface 902, and any automatically added objects, in the order identified by the user. The order may be simply the order in which the user selects the objects, or the user may rearrange the objects, such as by dragging the objects within a window (not shown). The new document 916 may be stored by the computer programming interface 106 in the document storage system 102, as shown at 918, or the new document 916 may be stored in another storage location. It should be noted that, as used herein, the term “object” includes a notion of a “page.” A page may act as a receptacle for other objects, i.e., a page is a collection of other objects. Thus, “rearranging,” as described above, includes dragging an object, such as a graph, into an existing or newly created page.

In some embodiments, the document generator 914 generates the new document 916 by copying the user-selected objects from their respective source documents in the document storage system 102, while maintaining formatting of the objects as in the source documents. This may be acceptable, particularly if the source documents are similarly formatted or they were created according to similar or identical templates or themes. However, if the objects' formats are sufficiently different to be disharmonious, the user may choose to command the document generator 914 (via the object selection user interface 902) to generate the new document 916, such that the selected objects are all formatted alike. In such a case, the document generator 914 fetches the normalized versions of the user-selected objects from the index database 108 and applies a single format, including font, type size, bolding, orientation, color, etc., to the normalized objects as the objects are being placed into the new document 916, thereby generating the new document 916 with a uniform format.

Thus, in such a case, the document generator 914 is configured to format a presentation aspect of at least one of the objects identified by the user, so as to make the presentation aspect consistent with other of the objects identified by the user.

The document curation system, including its various components, such as the computer programming interface 106, the document analyzer 110, the object normalizer 112, the object score calculator 116 and the indexer 120, are referred to as modules. Among other implementations, each module may be a single integrated unit having the discussed functionality and/or a plurality of interconnected separate functional devices. Reference to a “module” therefore is for convenience and not intended to limit its implementation. Moreover, the various functionalities within the modules may be implemented in any number of ways, such as by one or more application specific integrated circuits (ASICs) or digital signal processors (DSPs), or the discussed functionality may be implemented in software or a combination of software and hardware. The various modules may be implemented by a processor executing instructions stored in a memory.

While the invention is described through the above-described exemplary embodiments, modifications to, and variations of, the illustrated embodiments may be made without departing from the inventive concepts disclosed herein. Furthermore, disclosed aspects, or portions thereof, may be combined in ways not listed above and/or not explicitly claimed. Accordingly, the invention should not be viewed as being limited to the disclosed embodiments.

Although aspects of embodiments may be described with reference to flowcharts and/or block diagrams, functions, operations, decisions, etc. of all or a portion of each block, or a combination of blocks, may be combined, separated into separate operations or performed in other orders. All or a portion of each block, or a combination of blocks, may be implemented as computer program instructions (such as software), hardware (such as combinatorial logic, Application Specific Integrated Circuits (ASICs), Field-Programmable Gate Arrays (FPGAs) or other hardware), firmware or combinations thereof. Embodiments may be implemented by a processor executing, or controlled by, instructions stored in a memory. The memory may be random access memory (RAM), read-only memory (ROM), flash memory or any other memory, or combination thereof, suitable for storing control software or other instructions and data. Instructions defining the functions of the present invention may be delivered to a processor in many forms, including, but not limited to, information permanently stored on tangible non-writable storage media (e.g., read-only memory devices within a computer, such as ROM, or devices readable by a computer I/O attachment, such as CD-ROM or DVD disks), information alterably stored on tangible writable storage media (e.g., floppy disks, removable flash memory and hard drives) or information conveyed to a computer through a communication medium, including wired or wireless computer networks. Moreover, while embodiments may be described in connection with various illustrative data structures, systems may be embodied using a variety of data structures.

What is claimed is:

1. A document curation system for curating objects from documents stored in a document storage system, each document containing at least one object and being organized according to one of a plurality of predefined object models, the document storage system including an application programming interface (API) and also storing information about each document, the document curation system comprising:
a computer programming interface that fetches documents, as well as information about the documents, from the document storage system via the document storage system's API;
a document analyzer that automatically identifies the object model of each fetched document and automatically identifies objects in the fetched document, according to the object model of the fetched document;
an object normalizer that automatically creates a normalized version of each identified object, the normalized version of the identified object being independent of the object model of the fetched document and excluding characteristics from the identified object that are irrelevant to contents of the identified object;
a hash calculator that automatically calculates a hash value based on each identified object;
an object score calculator that calculates a relevance score for each identified object, independent of any user-initiated search;
a metadata generator that automatically generates metadata about each identified object, the metadata including information sufficient to fetch the object from the document storage system;
an index database, distinct from the document storage system, configured to store information about individual objects; and
an indexer that stores the normalized version of the identified object, the hash value, the relevance score and the metadata in the index database for each of a plurality of objects identified by the document analyzer.

2. A system as define in claim 1, wherein the object score calculator calculates the relevance score based at least in part on identity of an author of the object.

3. A system as define in claim 1, wherein the object score calculator calculates the relevance score based at least in part on frequency with which identical objects exist in other documents in the document storage system.

4. A system as define in claim 1, wherein the object score calculator calculates the relevance score based at least in part on frequency with which similar, but not identical, objects exist in other documents in the document storage system.

5. A system as define in claim 1, wherein the object score calculator calculates the relevance score based at least in part on frequency with which the object has been included in at least one newly created document.

6. A system as define in claim 1, wherein the metadata further includes information identifying an author of the object and information identifying each user who has used the object in a newly created document.

7. A system as define in claim 1, further comprising:
a first user interface that receives a query from a human user;
a search engine that searches the index database and identifies objects that meet criteria established by the query;
a de-duplicator that uses hash values to identify, among the objects identified by the search engine, objects that are at least similar, within a predetermined similarity range, to other objects identified by the search engine; and
a second user interface that displays objects identified by the search engine, other than the at least similar objects identified by the de-duplicator.

8. A system as defined in claim 7, further comprising:
a third user interface that receives indications from the human user identifying ones of the objects displayed by the second user interface and identifying an order of the objects; and
a document generator that generates a document containing copies of the objects identified by the human user in the third user interface, in the order identified by the human user.

9. A system as defined in claim 8, wherein the document generator formats a presentation aspect of at least one of the objects identified by the human user, so as to make the presentation aspect consistent with other of the objects identified by the human user.

10. A system as define in claim 1, further comprising:
a first user interface that receives a query from a human user;
a search engine that searches the index database and identifies objects that meet criteria established by the query;
a duplicate identifier that uses hash values to identify, among the objects identified by the search engine, objects that are at least similar, within a predetermined similarity range, to other objects identified by the search engine; and
a second user interface that displays objects identified by the search engine and indicates whether at least similar objects were identified by the duplicate identifier.

11. A system as define in claim 1, further comprising:
a first user interface that receives a query from a human user;
a search engine that searches the index database and identifies objects that meet criteria established by the query;
a de-duplicator that uses hash values to identify, among the objects identified by the search engine, objects that are at least similar, within a predetermined similarity range, to other objects identified by the search engine and, thereby, identify a de-duplicated set of objects that does not include the at least similar objects;
an object analyzer that parses the de-duplicated set of objects to automatically identify references to additional objects that are not in the objects identified by the search engine;
a document organizer that automatically determines an order for the de-duplicated set of objects and the additional objects, according to an order of the references identified by the object analyzer; and
a document generator that automatically generates a document containing copies of the de-duplicated set of objects and the additional objects, according to the order determined by the document organizer.

12. A system as define in claim 11, further comprising:
a second user interface that receives indications from the human user identifying ones of the de-duplicated set of objects and the additional objects; and wherein:
the document generator generates the document, according to the objects identified by the human user in the second user interface.

13. A system as define in claim 11, further comprising a natural language processor that:
automatically processes the query from the human user to automatically identify at least one keyword, according to a meaning of the query from the human user; and
establishes the criteria for the search engine from the at least one keyword.

14. A system as define in claim 11, further comprising a text adjuster that changes text in at least one object of the de-duplicated set of objects and the additional objects, so as to make wording of the text correct, based on the order determined by the document organizer.

15. A system as define in claim 11, wherein the document generator formats a presentation aspect of at least one of the objects identified by the human user, so as to make the presentation aspect consistent with other of the objects identified by the human user.
